(19) United States
(12) Patent Application Publication
(10) Pub. No.: US 2026/0336451 A1
(43) Pub. Date: Oct. 29, 2026

(54) ELECTRIC VEHICLE CHARGING SYSTEM AND METHOD FOR OPERATING THE SAME

(71) Applicant: DELTA ELECTRONICS, INC., Taoyuan City (TW)

(72) Inventors: Han-Min LEE, Taoyuan City (TW); Guan-Chun LI, Taoyuan City (TW)

(21) Appl. No.: 19/573,637

(22) Filed: Mar. 20, 2026

Related U.S. Application Data
(60) Provisional application No. 63/793,269, filed on Apr. 23, 2025.

(30) Foreign Application Priority Data
Oct. 16, 2025 (TW) 114139929

(51) Int. Cl. B60L 53/60; B60L 55/00; H02J 3/32; H02J 9/06

(52) U.S. Cl. CPC B60L 53/60; B60L 55/00; H02J 3/322; H02J 9/062; B60L 2210/30; B60L 2210/42

(57) ABSTRACT

An electric vehicle charging system includes an electric vehicle charger for coupling an electric vehicle, a mains, and a load. The electric vehicle charger includes a switching switch having a first terminal, a second terminal, and a third terminal, an auxiliary power circuit, a driving circuit, and a control circuit. When the mains fails and the electric vehicle provides a vehicle power to the electric vehicle charger, the driving circuit receives the vehicle power and to be activated. The driving circuit controls the second terminal and the third terminal of the switching switch to be connected so that the auxiliary power circuit receives the vehicle power through a path from the second terminal to the third terminal. The auxiliary power circuit receives the vehicle power and converts the vehicle power into an auxiliary power so as to activate the control circuit through the auxiliary power.

### CROSS-REFERENCE TO RELATED APPLICATION

This patent application claims the benefit of U.S. Provisional Patent Application No. 63/793,269, filed Apr. 23, 2025, which is incorporated by reference herein.

### BACKGROUND

### Technical Field

The present disclosure relates to an electric vehicle charging system and a method for operating the same, and more particularly to an electric vehicle charging system with vehicle-to-home operation and a method for operating the same.

### Description of Related Art

The statements in this section merely provide background information related to the present disclosure and do not necessarily constitute prior art.

Electric vehicles are increasingly being replaced by electric power, shifting from fuel to electricity, driven by energy conservation and carbon reduction. Since the power source of an electric vehicle is a battery, the battery needs to be charged to maintain the driving range of the electric vehicle. On the other hand, since the batteries in electric vehicles can store electricity, when the electric vehicle has sufficient power, it can also be used to feed power back to an electric vehicle charging system to supply power to household loads connected to the system, and this operating mode is also known as vehicle-to-home (V2H). However, in previous electric vehicle charging systems, the need to supply power to household loads with an electric vehicle often occurred when the mains is interrupted. As a result, the controller within the electric vehicle charging system could not be properly activated due to the lack of power, preventing the electric vehicle charging system from communicating with the electric vehicle and setting the operating mode. This resulted in inconvenience and difficulty in setting the operating mode. In order to ensure that the internal circuitry of the electric vehicle charger in an electric vehicle charging system remains operational when the mains is interrupted, there are two common technologies:
1. Electric vehicle chargers have built-in backup batteries. When the mains is disconnected, the electric vehicle charger uses the backup battery to maintain the controller to operate. Therefore, when an electric vehicle is connected to the electric vehicle charging system, the controller can communicate with the electric vehicle to activate vehicle-to-home (V2H) operation. However, a disadvantage of this technology is that the backup battery can only operate for a limited time. Therefore, if the battery is depleted, aged, or damaged, the controller inside the electric vehicle charger cannot be activated, and thus cannot communicate with the electric vehicle to enter vehicle-to-home (V2H) operation.
2. Electric vehicle chargers can be supplied power externally. When the mains is disconnected, the controller loses power and cannot operate. However, the controller can be supplied power through the external power connector on the electric vehicle charger to activate communication with the electric vehicle and enable vehicle-to-home (V2H) operation. However, a drawback of this technology is that the user must first supply power to the controller inside the electric vehicle charger to use V2H functionality. Therefore, if an external power source is unavailable or the corresponding cables are unavailable, the controller will not activate and will be unable to communicate with the electric vehicle to enter V2H operation.

Therefore, how to design an electric vehicle charging system and a method of operating the same so that when the electric vehicle is connected to the electric vehicle charging system without external power supply or battery, and the internal controller of the electric vehicle charger is out of power, the control circuit inside the electric vehicle charger can be activated to set the vehicle-to-home operation has become a critical topic in this field.

### SUMMARY

In order to solve the above-mentioned problems, the present disclosure provides an electric vehicle charging system configured to couple to an electric vehicle, a mains, and a load. The electric vehicle charging system includes an electric vehicle charger. The electric vehicle charger is coupled to the electric vehicle, the mains, and the load. The electric vehicle charger includes a first switch, a switching switch, an auxiliary power circuit, a driving circuit, and a control circuit. A first terminal of the first switch is coupled to the mains through a mains terminal, and a second terminal of the first switch is coupled to the electric vehicle through a vehicle terminal. The switching switch includes a first terminal, a second terminal, a third terminal, and a control terminal. The first terminal of the switching switch is coupled between the first switch and the mains terminal, and the second terminal of the switching switch is coupled between the first switch and the vehicle terminal. The auxiliary power circuit is coupled to the third terminal of the switching switch. The driving circuit is coupled to the second terminal of the switching switch and the control terminal of the switching switch. The control circuit is coupled to the auxiliary power circuit. When the mains fails and the electric vehicle provides a vehicle power to the vehicle terminal, the driving circuit receives the vehicle power and controls the second terminal and the third terminal of the switching switch to be connected through the control terminal so that the auxiliary power circuit receives the vehicle power from the third terminal, and accordingly the auxiliary power circuit converts the vehicle power into an auxiliary power to activate the control circuit.

In order to solve the above-mentioned problems, the present disclosure provides a method for operating an electric vehicle charging system.

The electric vehicle charging system includes an electric vehicle charger coupled to an electric vehicle, a mains, and a load. The electric vehicle charger includes a switching switch having a first terminal, a second terminal, a third terminal, an auxiliary power circuit, a driving circuit, and a control circuit. The method includes steps of: activating the driving circuit by receiving, by the driving circuit, a vehicle power when the mains fails and the electric vehicle provides the vehicle power to the electric vehicle charger; controlling, by the driving circuit, the second terminal and the third terminal of the switching switch to be connected so that the auxiliary power circuit receives the vehicle power through a path from the second terminal to the third terminal; converting, by the auxiliary power circuit, the vehicle power into an auxiliary power to activate the control circuit.

The primary purpose and effect of the present disclosure is to provide an electric vehicle charging system that requires only a user to connect the electric vehicle charger to the electric vehicle using a charging gun. The electric vehicle then provides vehicle power to the electric vehicle charger, either through settings of the electric vehicle or by utilizing self-driving circuit inside the electric vehicle charger. Therefore, this allows the system to be used to activate the control circuit using vehicle power, even if the internal control circuit of the electric vehicle charger is dead, and allows the system to be used to set the vehicle-to-home operation.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1A is a block circuit diagram of an electric vehicle charging system according to a first embodiment of the present disclosure.

FIG. 1B is a block circuit diagram of the electric vehicle charging system according to a second embodiment of the present disclosure.

FIG. 2A is a block circuit diagram of an electric vehicle charger according to a first embodiment of the present disclosure.

FIG. 2B is a flowchart of operating the electric vehicle charger according to a first embodiment of the present disclosure.

FIG. 3A is a power path diagram of the electric vehicle charger in a charging mode according to a first embodiment of the present disclosure.

FIG. 3B is a flowchart of operating the electric vehicle charger in the charging mode according to a first embodiment of the present disclosure.

FIG. 4A is a power path diagram of the electric vehicle charger in a discharging mode according to a first embodiment of the present disclosure.

FIG. 4B is a flowchart of operating the electric vehicle charger in the discharging mode according to a first embodiment of the present disclosure.

FIG. 5 is a circuit diagram of an AC conversion circuit according to the present disclosure.

FIG. 6A is a power path diagram of the electric vehicle charger when a mains is restored according to a first embodiment of the present disclosure.

FIG. 6B is a flowchart of operating the electric vehicle charger when the mains is restored according to a first embodiment of the present disclosure.

FIG. 7A is a block circuit diagram of a driving circuit according to a first embodiment of the present disclosure.

FIG. 7B is a block circuit diagram of the driving circuit according to a second embodiment of the present disclosure.

FIG. 7C is a block circuit diagram of a power supply circuit according to a first embodiment of the present disclosure.

FIG. 7D is a block circuit diagram of the power supply circuit according to a second embodiment of the present disclosure.

FIG. 8A is a block circuit diagram of the electric vehicle charger according to a second embodiment of the present disclosure.

FIG. 8B is a flowchart of operating the electric vehicle charger according to a second embodiment of the present disclosure.

FIG. 8C is a block circuit diagram of a self-driving circuit according to a first embodiment of the present disclosure.

FIG. 8D is a block circuit diagram of the self-driving circuit according to a second embodiment of the present disclosure.

FIG. 8E is a schematic diagram of a circuit structure in which a third switch and a fourth switch according to the present disclosure.

FIG. 9A is a power path diagram of the electric vehicle charger in the charging mode according to a second embodiment of the present disclosure.

FIG. 9B is a flowchart of operating the electric vehicle charger in the charging mode according to a second embodiment of the present disclosure.

FIG. 10A is a power path diagram of the electric vehicle charger when the mains fails, the self-driving circuit has power, and the electric vehicle is coupled according to a second embodiment of the present disclosure.

FIG. 10B is a power path diagram of the electric vehicle charger when the self-driving circuit has power to enter the discharging mode according to a second embodiment of the present disclosure.

FIG. 10C is a flowchart of operating the electric vehicle charger in the discharging mode according to a second embodiment of the present disclosure.

FIG. 11A is a power path diagram of the electric vehicle charger when the mains fails and the self-driving circuit has no power to enter the discharging mode according to a second embodiment of the present disclosure.

FIG. 11B is a flowchart of operating the electric vehicle charger when the self-driving circuit has no power and in the discharging mode according to a second embodiment of the present disclosure.

FIG. 12A is a power path diagram of the electric vehicle charger when the mains is restored according to a second embodiment of the present disclosure.

FIG. 12B is a flowchart of operating the electric vehicle charger when the mains is restored according to a second embodiment of the present disclosure.

FIG. 13 is a block circuit diagram of the electric vehicle charger according to a third embodiment of the present disclosure.

FIG. 14A is a power path diagram of the electric vehicle charger in the charging mode according to a third embodiment of the present disclosure.

FIG. 14B is a flowchart of operating the electric vehicle charger in the charging mode according to a third embodiment of the present disclosure.

FIG. 15A is a power path diagram of the electric vehicle charger in the discharging mode according to a third embodiment of the present disclosure.

FIG. 15B is a flowchart of operating the electric vehicle charger in the discharging mode according to a third embodiment of the present disclosure.

FIG. 16A is a power path diagram of the electric vehicle charger when the mains is restored according to a third embodiment of the present disclosure.

FIG. 16B is a flowchart of operating the electric vehicle charger when the mains is restored according to a third embodiment of the present disclosure.

FIG. 17 is a block circuit diagram of the electric vehicle charger according to a fourth embodiment of the present disclosure.

FIG. 18A is a power path diagram of the electric vehicle charger in the charging mode according to a fourth embodiment of the present disclosure.

FIG. 18B is a flowchart of operating the electric vehicle charger in the charging mode according to a fourth embodiment of the present disclosure.

FIG. 19A is a power path diagram of the electric vehicle charger in the discharging mode according to a fourth embodiment of the present disclosure.

FIG. 19B is a flowchart of operating the electric vehicle charger in the discharging mode according to a fourth embodiment of the present disclosure.

FIG. 20A is a power path diagram of the electric vehicle charger when the mains is restored according to a fourth embodiment of the present disclosure.

FIG. 20B is a flowchart of operating the electric vehicle charger when the mains is restored according to a fourth embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

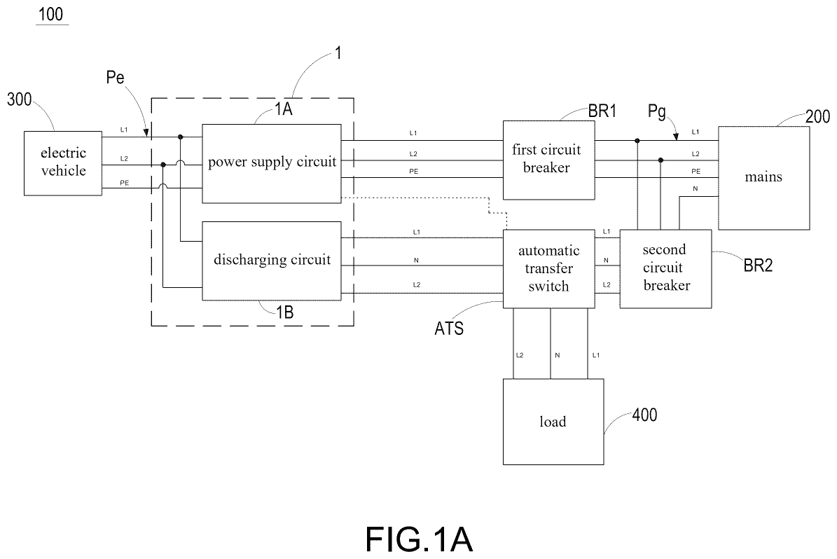

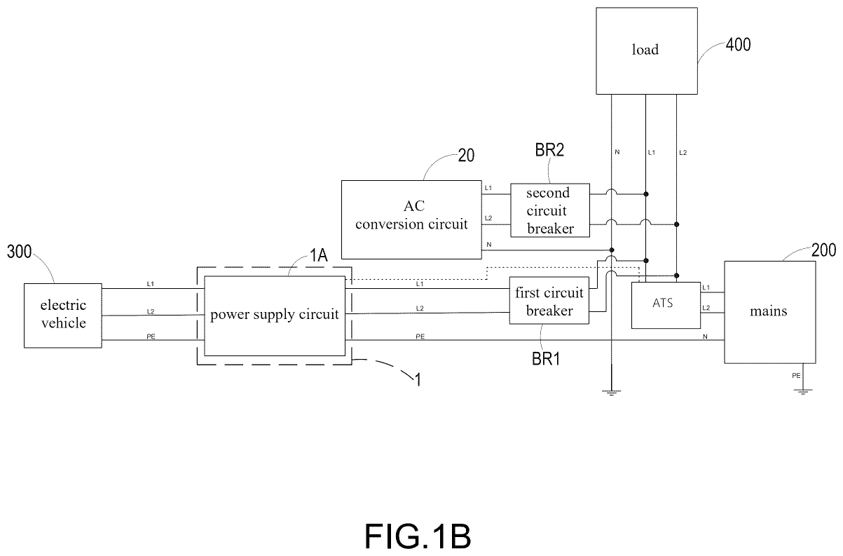

Please refer to FIG. 1A, which shows a block circuit diagram of an electric vehicle charging system according to a first embodiment of the present disclosure. The electric vehicle charging system 100 mainly provides vehicle-to-home (V2H) operation without relying on an external power supply and requiring additional wiring. The electric vehicle charging system 100 is configured to couple a mains 200, an electric vehicle 300, and a load 400 (such as, but not limited to, household appliances). Specifically, the electric vehicle charging system 100 includes a first circuit breaker BR1, a second circuit breaker BR2, an automatic transfer switch ATS, and an electric vehicle charger 1. The first circuit breaker BR1, the second circuit breaker BR2, and the automatic transfer switch ATS are one embodiment of a typical distribution board structure, mainly determined by the internal structure of the electric vehicle charger 1 and the configuration of the electric vehicle charging system 100, but are not limited thereto. The first circuit breaker BR1 and the second circuit breaker BR2 are coupled to the mains 200, and the automatic transfer switch ATS is coupled to the second circuit breaker BR2. The first circuit breaker BR1 and the second circuit breaker BR2 are mainly designed to disconnect a path when the power flowing through them exceeds a rated upper limit, thereby preventing damage to the electric vehicle charging system 100 from faults such as overcurrent, overload, or short circuit. The electric vehicle charger 1 is coupled to the first circuit breaker BR1 and the automatic transfer switch ATS. The electric vehicle charger 1 may charge or discharge the electric vehicle 300 by connecting it to the electric vehicle 300 through, for example, but not limited to, a charging gun (not shown).

The automatic transfer switch (ATS) is further coupled to the load 400 and is mainly used to selectively switch the power source for the load 400 between the electric vehicle 300 (through the electric vehicle charger 1) and the mains 200, i.e., selectively switch the electric vehicle 300 or the mains 200 to supply power to the load 400. In one embodiment, when the mains 200 is disconnected, the automatic transfer switch (ATS) automatically switches (or its internal controller controls the switching) to connect the path between the electric vehicle charger 1 and the load 400 and disconnects the path between the mains 200 and the load 400, thereby switching the power source to the electric vehicle 300. Furthermore, the electric vehicle charging system 100 of the first embodiment of the present disclosure is mainly applicable to unidirectional power supply systems, i.e., power supply in a single direction. When the mains 200 is available (i.e., the mains 200 normally supplies power), the mains 200 can provide supplying power Pg to the electric vehicle charger 1 and the automatic transfer switch (ATS), and the electric vehicle charger 1 can charge the electric vehicle 300 according to the supplying power Pg. Furthermore, the automatic transfer switch ATS switches to a path connecting the mains 200 to the load 400 so that the supplying power Pg is provided to the load 400 through the automatic transfer switch ATS.

In conventional technology, when the mains fails (i.e., the mains is disconnected or abnormally unable to supply power), the electric vehicle charging system loses its power source, thereby forcing the electric vehicle charger to shut down and become unable to actively perform any operations. Therefore, in conventional technology, even if the electric vehicle is connected to the electric vehicle charging system, the electric vehicle charger is shut down and unable to set any operating mode. As a result, the electric vehicle will not provide any power to the electric vehicle charger, thereby leaving the electric vehicle charging system in a power-off state and unable to perform any operations. Therefore, in conventional technology, the electric vehicle charger uses additional wiring to connect to an external power source so that a controller (not shown) within the electric vehicle charger can continue to operate even when the mains fails. This allows the controller within the electric vehicle charger to notify the electric vehicle to provide power when the mains fails and the electric vehicle is connected to the electric vehicle charging system.

However, a key feature of the present disclosure lies in the fact that the electric vehicle charging system 100 does not rely on an external power source and requires no additional wiring. It is to simply connect the electric vehicle charger 1 and the electric vehicle 300 through a charging gun to enable vehicle-to-home (V2H) operation. Therefore, the user simply connects the electric vehicle charger 1 and the electric vehicle 300 through a charging gun and then, through the settings of the electric vehicle 300 or the use of an internal self-driving circuit (not shown), thereby causing the electric vehicle 300 to provide vehicle power Pe to the electric vehicle charger 1. This activates the controller within the electric vehicle charger 1 to set the vehicle-to-home (V2H), hereinafter referred to as the discharging mode operation. Furthermore, after the controller within the electric vehicle charger 1 is activated and the automatic transfer switch ATS is switched to connect the electric vehicle charger 1 and the load 400, the electric vehicle charger 1 can supply power to the load 400 according to the vehicle power Pe provided by the electric vehicle 300. Therefore, the electric vehicle charging system 100 operates in a unidirectional manner, regardless of whether it is powered (supplied power) by the mains 200 or the electric vehicle 300. However, in one embodiment, the electric vehicle charger 1 can enable bidirectional charging and discharging of the electric vehicle 300 and the mains 200 through additional design (not specifically described in the present disclosure) so as to have a vehicle-to-grid (V2G) operation, which is not limited here.

Referring to FIG. 1A again, the electric vehicle charging system 100 is applicable to a single-phase, three-wire power system, which includes two live wires L1, L2, a neutral wire N, and a ground wire PE. The electric vehicle charger 1 includes a unidirectional power supply circuit 1A and a discharging circuit 1B. The power supply circuit 1A is coupled to the mains 200 and the electric vehicle 300. When the mains 200 is available, the power supply circuit 1A charges the electric vehicle 300 with the supplying power Pg. Therefore, in this embodiment, the power supply circuit 1A serves as a charging circuit for the electric vehicle 300. The discharging circuit 1B is coupled to the electric vehicle 300 and the load 400. When the mains 200 fails, the discharging circuit 1B supplies power to the load 400 with the vehicle power Pe provided by the electric vehicle 300. In particular, the power supply circuit 1A may be coupled to an automatic transfer switch (ATS) (indicated by a dashed line) to control the automatic transfer switch (ATS) to selectively switch the power source for the load 400 between the electric vehicle 300 and the mains 200 based on its own operating state. Furthermore, in one embodiment, the discharging circuit 1B of the present disclosure can utilize a specific structure to convert the vehicle power Pe, and this will be further described below and will not be further described here. Furthermore, in one embodiment, the discharging circuit 1B may be included within the electric vehicle charger 1 or connected externally to the electric vehicle charger 1 independently, which is not limited here.

Please refer to FIG. 1B, which shows a block circuit diagram of the electric vehicle charging system according to a second embodiment of the present disclosure, and also refer to FIG. 1A. The electric vehicle charging system 100 of FIG. 1B differs from the electric vehicle charging system 100 of FIG. 1A in that the charging and discharging paths of the electric vehicle charger 1 are the same, and the electric vehicle charging system 100 optionally includes an AC conversion circuit 20. Specifically, the electric vehicle charging system 100 also includes a first circuit breaker BR1, a second circuit breaker BR2, an automatic transfer switch ATS, and the electric vehicle charger 1. The first circuit breaker BR1, the second circuit breaker BR2, and the automatic transfer switch ATS are also another embodiment of a typical distribution board structure, mainly determined by the internal structure of the electric vehicle charger 1 and the configuration of the electric vehicle charging system 100, and are not limited thereto. For example, but not limited to, when the electric vehicle charging system 100 does not include the AC conversion circuit 20, the second circuit breaker BR2 may be omitted. Conversely, when the electric vehicle charging system 100 includes the AC conversion circuit 20, the electric vehicle charging system 100 may be configured with a second circuit breaker BR2 to couple to the AC conversion circuit 20. The automatic transfer switch ATS is coupled the mains 200 and the load 400, and the first circuit breaker BR1 and the second circuit breaker BR2 are coupled to a power path from the automatic transfer switch ATS to the load 400. The electric vehicle charger 1 is coupled to the first circuit breaker BR1, and the electric vehicle charger 1 may be connected to the electric vehicle 300 through, for example, but not limited to, a charging gun (not shown) to charge or discharge the electric vehicle 300.

Furthermore, the electric vehicle charging system 100 of the second embodiment of the present disclosure is mainly suitable for systems with bidirectional power supply, i.e., power supply in both directions. When the mains 200 is available (i.e., the mains 200 normally supplies power), the mains 200 can provide supplying power Pg to the electric vehicle charger 1 through the automatic transfer switch (ATS), and the electric vehicle charger 1 can charge the electric vehicle 300 according to the supplying power Pg. Furthermore, when the mains 200 fails (i.e., the mains 200 is disconnected or abnormal, preventing normal power supply), the electric vehicle charger 1 and the electric vehicle 300 can be connected using a charging gun to activate vehicle-to-home (V2H) operation. According to the vehicle power Pe provided by the electric vehicle 300, the electric vehicle charger 1 supplies the first AC power Pac1 and the second AC power Pac2 to the load 400, thereby supplying power to the load 400 through the first circuit breaker BR1. In this condition, the automatic transfer switch (ATS) can selectively switch on or off according to the needs of the mains 200 and whether the electric vehicle charger 1 is capable of vehicle-to-grid (V2G) operation. Taking disconnection as an example, the automatic transfer switch (ATS) can disconnect the path between the mains 200 and the electric vehicle charging system 100, and no power is fed back to the mains 200.

Referring to FIG. 1B again, the electric vehicle charger 1 includes a bidirectional power supply circuit 1A coupled to the mains 200 and the electric vehicle 300. When the mains 200 is available, the power supply circuit 1A charges the electric vehicle 300 with the supplying power Pg. When the mains 200 fails, the power supply circuit 1A supplies power to the load 400 with the vehicle power Pe provided by the electric vehicle 300. The power supply circuit 1A is also coupled to an automatic transfer switch ATS (shown by a dashed line) to selectively disconnect the electric vehicle charging system 100 from the mains 200 according to its operating state. The AC conversion circuit 20 is coupled to the power path from the automatic transfer switch ATS to the load 400 through the second circuit breaker BR2. The AC conversion circuit 20 is mainly used to maintain voltage balance on the two live wires L1, L2 when the electric vehicle charger 1 supplies power to the load 400 with the vehicle power Pe provided by the electric vehicle 300.

Furthermore, in one embodiment, the AC conversion circuit 20 is preferably a split-phase conversion circuit. The split-phase conversion circuit mainly converts single-phase power into two-phase or three-phase power, shifting the phase of the input power so that it has a specific phase difference of 180 degrees with the original power (i.e., the split-phase conversion circuit mainly converts a single-phase two-wire power into a single-phase three-wire power). Since the load 400 is selectively activated according to user behavior, there may be a power imbalance between the first AC power Pac1 and the second AC power Pac2 on the two live wires L1, L2 (for example, but not limited to, a clothes dryer load on one live wire and a desk lamp load on the other live wire). Therefore, the split-phase conversion circuit can convert the unbalanced supplying power Pg and compensate for the lower-power phase wire to balance the supplying power Pg. Therefore, if the supplying power Pg provided by the electric vehicle charger 1 is a single-phase AC output, it can be split-phase converted into two-phase first AC power Pac1 and two-phase second AC power Pac2 by the split-phase conversion circuit. Based on the power consumption on the two live wires L1, L2, the first AC power Pac1 and the second AC power Pac2 are compensated to achieve power balance on the two live wires L1, L2. In one embodiment, the circuit structure, coupling relationships, and operation methods not illustrated in FIG. 1B may also refer to FIG. 1A and its related description, and will not be further described here. Furthermore, in one embodiment, the details of the split-phase conversion circuit will be further described later and will not be further described here.

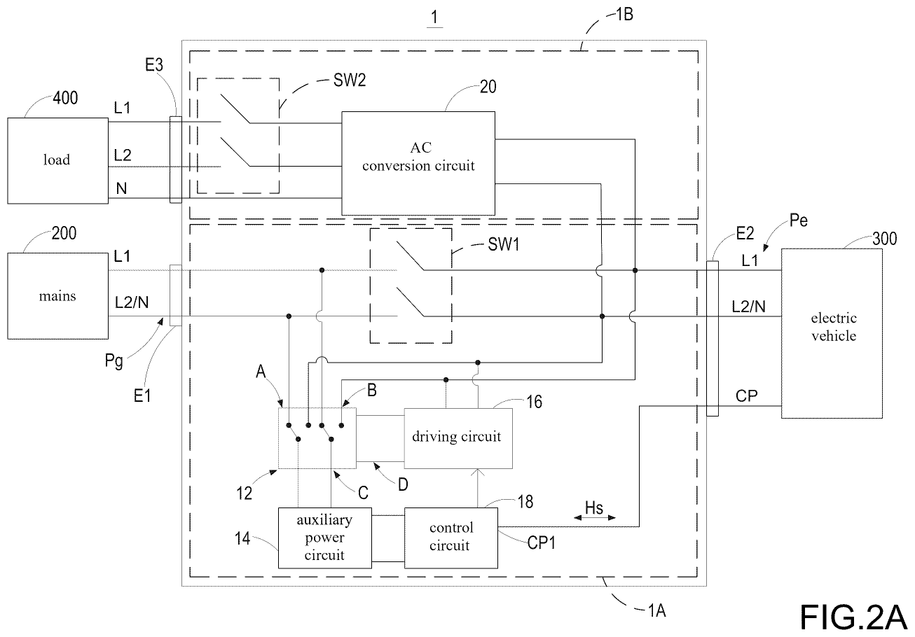

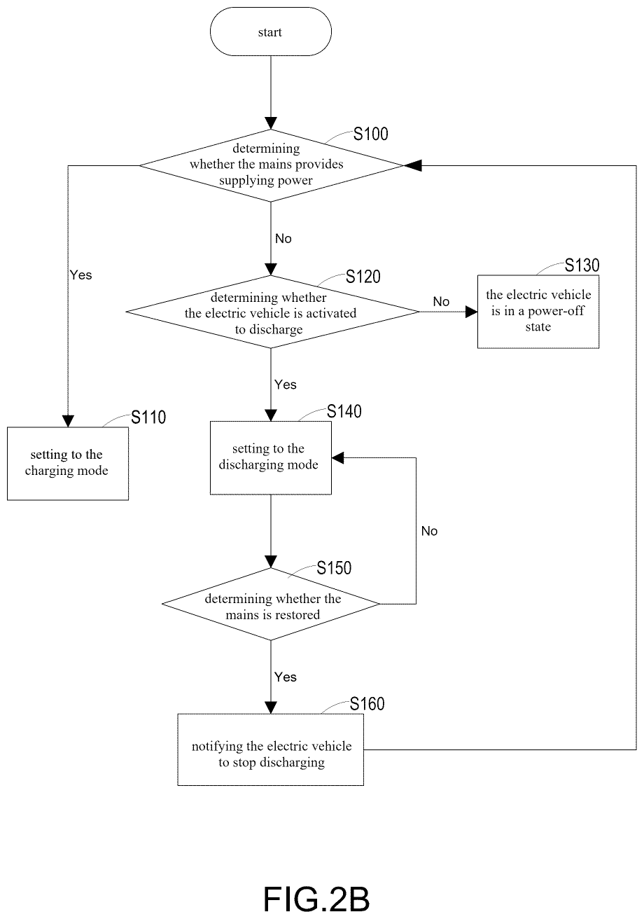

Please refer to FIG. 2A, which shows a block circuit diagram of an electric vehicle charger according to a first embodiment of the present disclosure; please refer to FIG. 2B, which shows a flowchart of operating the electric vehicle charger according to a first embodiment of the present disclosure, and also refer to FIG. 1A. In FIG. 2A, the electric vehicle charger 1 includes a first switch SW1, a switching switch 12, an auxiliary power circuit 14, a driving circuit 16, a control circuit 18, a second switch SW2, and an AC conversion circuit 20. The first switch SW1, the switching switch 12, the auxiliary power circuit 14, the driving circuit 16, and the control circuit 18 may constitute the power supply circuit 1A described in FIG. 1A, and the second switch SW2 and the AC conversion circuit 20 may constitute the discharging circuit 1B described in FIG. 1A. A first terminal of the first switch SW1 is coupled to the mains 200 through a mains terminal E1, and a second terminal of the first switch SW1 is coupled to the electric vehicle 300 through a vehicle terminal E2. The switching switch 12 may be, for example, but not limited to, a three-terminal switch, including a first terminal A, a second terminal B, a third terminal C, and a control terminal D. The first terminal A is coupled between the first switch SW1 and the mains terminal E1, and the second terminal B is coupled between the first switch SW1 and the vehicle terminal E2. The auxiliary power circuit 14 is coupled to the third terminal C, and the driving circuit 16 is coupled to the second terminal B and the control terminal D.

A first terminal of the AC conversion circuit 20 is coupled to the second terminal B and the vehicle terminal E2, and a second terminal of the AC conversion circuit 20 is coupled to a first terminal of the second switch SW2. A second terminal of the second switch SW2 is coupled to the load terminal E3, and is coupled to the load 400 through the load terminal E3. The control circuit 18 is coupled to the auxiliary power circuit 14 and the driving circuit 16, and the control circuit 18 includes a control pilot terminal CP1. The control pilot terminal CP1 is coupled to an on-board charger (OBC) of the electric vehicle 300 through the vehicle terminal E2, thereby enabling the control circuit 18 to perform handshake communication Hs with the control pilot terminal CP of the electric vehicle 300 through the control pilot terminal CP1. In particular, the control circuit 18 may include a controller for controlling the electric vehicle charger 1 and its peripheral circuits (such as, but not limited to, detection, control, and protection circuits). Furthermore, when the control circuit 18 is enabled (i.e., normally operates), the control circuit 18 can control the first switch SW1, the switching switch 12, the auxiliary power circuit 14, the driving circuit 16, the second switch SW2, and the AC conversion circuit 20 to control the electric vehicle charger 1 to provide the supplying power Pg to charge the electric vehicle 300 or provide the vehicle power Pe to discharge the load 400.

Specifically, referring to FIG. 2B, the operating method of the electric vehicle charger 1 of the first embodiment first includes determining whether the mains provides supplying power (S100). When the mains 200 provides the supplying power Pg, the control circuit 18 is enabled. After the control circuit 18 performs the handshake communication Hs with the electric vehicle 300 through the control pilot terminal CP1, the operating mode of the electric vehicle charger 1 is set to a charging mode in which the mains 200 charges the electric vehicle 300 (S110). Conversely, when the mains 200 does not provide the supplying power Pg, the control circuit 18 is disabled (i.e., it is out of power), thereby rendering it unable to perform any operations. Therefore, when the electric vehicle 300 is coupled to the electric vehicle charger 1, it is determined whether discharging the electric vehicle 300 is activated by the user (S120). That is, when the electric vehicle 300 is coupled to the electric vehicle charger 1, the user determines whether discharging the electric vehicle 300 is activated by configuring the electric vehicle 300, for example, but not limited to, a vehicle panel inside the electric vehicle 300. When the user does not enable the electric vehicle 300 to discharge, the electric vehicle charger 1 is in a power-off state (S130).

Conversely, when the user activates discharge on the electric vehicle 300, the electric vehicle 300 provides the vehicle power Pe to the vehicle terminal E2, thereby enabling the control circuit 18 to activate and control the electric vehicle charger 1. In this condition, the control circuit 18 also performs the handshake communication Hs with the electric vehicle 300 through the control pilot terminal CP1 and sets the operating mode of the electric vehicle charger 1 to a discharging mode (S140). In this mode, the control circuit 18 also detects whether the mains 200 has been restored (S150). If the mains 200 has not been restored, the process returns to step S140 to continue the detection. Conversely, when the control circuit 18 detects that the mains 200 has been restored, it notifies the electric vehicle 300 through the control pilot terminal CP1 to stop discharging (S160) and returns to step S100. In one embodiment, for clarity, the term “vehicle power Pe” as used in the present disclosure refers to the power supplied to the vehicle terminal E2 of the electric vehicle charger 1, which originates from the electric vehicle 300. The “supplying power Pg” refers to the power supplied to the mains terminal E1 of the electric vehicle charger 1. Therefore, in the charging mode (mains power 200 to electric vehicle 300), the “supplying power Pg” originates from the mains 200; while in the discharging mode (electric vehicle 300 to load 400), the “supplying power Pg” originates from the “vehicle power Pe” (regardless of whether it has undergone power conversion within the electric vehicle charger).

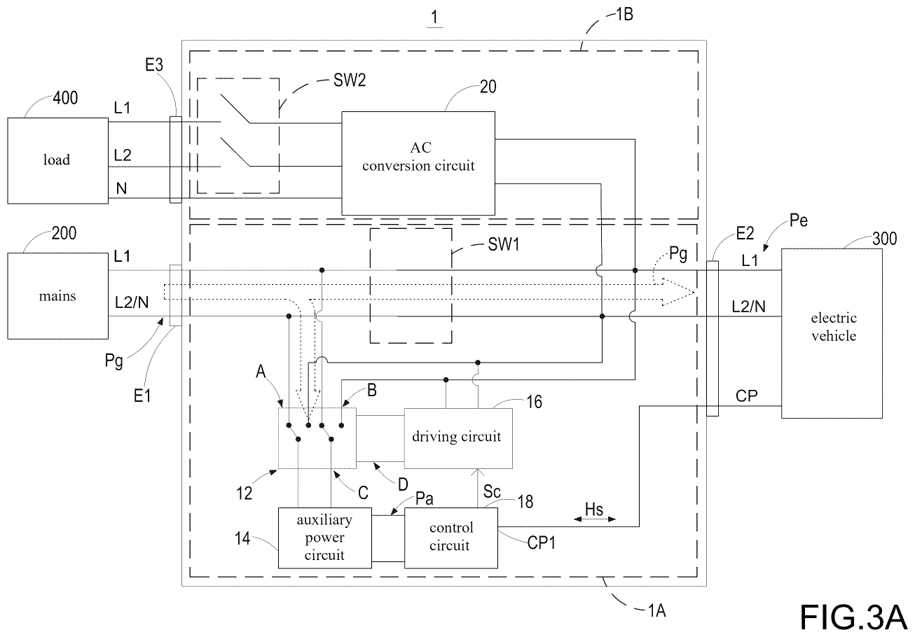

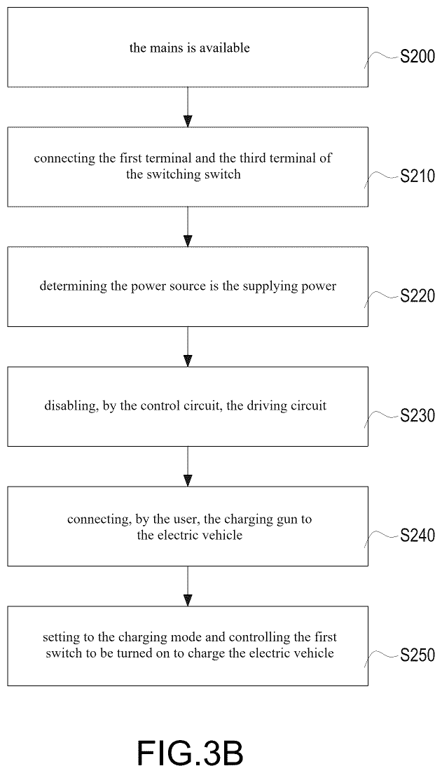

Please refer to FIG. 3A, which shows a power path diagram of the electric vehicle charger in a charging mode according to a first embodiment of the present disclosure; please refer to FIG. 3B, which shows a flowchart of operating the electric vehicle charger in the charging mode according to a first embodiment of the present disclosure, and also refer to FIG. 1A to FIG. 2B and with repeated reference to FIG. 3A and FIG. 3B. FIG. 3A mainly illustrates the power path of the supplying power Pg (i.e., the dashed arrows). Referring to FIG. 3B, when the mains is available (S200), the first terminal and the third terminal of the switching switch 12 are connected (S210). Specifically, the first terminal A and the third terminal C of the switching switch 12 may be in a normally closed (NC) state, meaning that when the switching switch 12 is in a normal, uncontrolled state, the first terminal A and the third terminal C are connected. Alternatively, the switching switch 12 may be controlled by the control circuit 18 to switch the terminals for connecting, without limitation. Therefore, when the first terminal A and the third terminal C are connected, the supplying power Pg provided from the mains 200 can be supplied to the auxiliary power circuit 14 through the path from the first terminal A to the third terminal C. The auxiliary power circuit 14 converts the supplying power Pg into an auxiliary power Pa, which is then used to activate the control circuit 18. Therefore, the control circuit 18 is activated, and the control circuit 18 determines whether the power source is the supplying power Pg.

When the control circuit is activated and determines that the power source is the supplying power (S220), the control circuit disables the driving circuit (S230). That is, the control signal Sc provided by the control circuit 18 disables the driving circuit 16, thereby causing the first terminal A and the third terminal C of the switching switch 12 to remain in a normally closed state, while the first terminal A and the third terminal C are continuously connected. At this time, the control circuit 18 continuously detects whether the electric vehicle 300 is coupled to the electric vehicle charger 1 through the control pilot terminal CP1. When the user operates the charging gun to connect to the electric vehicle (S240), the electric vehicle 300 is coupled to the electric vehicle charger 1. In this condition, the control circuit 18 performs a handshake communication Hs with the electric vehicle 300 through the control pilot terminal CP1. After the handshake communication is completed, the control circuit 18 sets the operating mode to the charging mode and controls the first switch to be turned on to charge the electric vehicle (S250). In other words, the control circuit 18 can short-circuit the path from the mains 200 to the electric vehicle 300 by controlling the first switch SW1 to be turned on, thereby allowing the electric vehicle 300 to be charged with the supplying power Pg. Furthermore, since the electric vehicle charging system 100 is mainly suitable for unidirectional power supply systems, when the first switch SW1 is turned on, the control circuit 18 can control the second switch SW2 to be turned off to prevent the supplying power Pg from being mistakenly supplied to the load 400 through the second switch SW2. In particular, there are many ways to short-circuit the path from the mains 200 to the electric vehicle 300, and the simplest method of controlling the switches to be turned on is used as an illustrative example, but the present disclosure is not limited to this method.

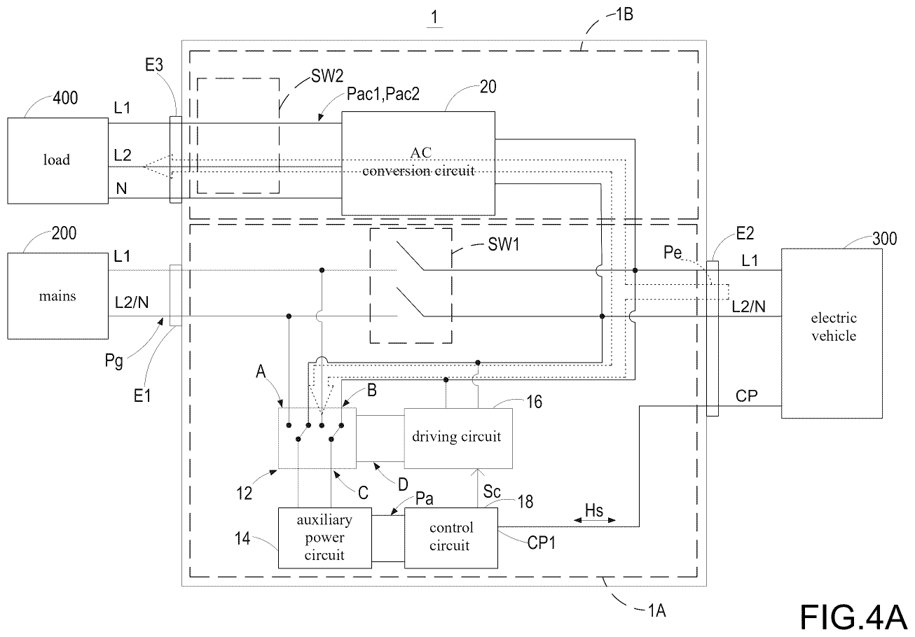

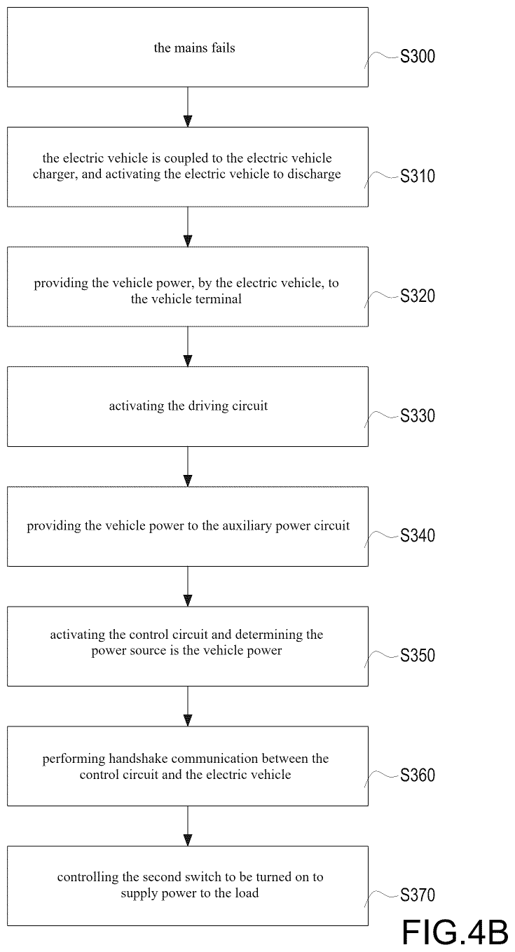

Please refer to FIG. 4A, which shows a power path diagram of the electric vehicle charger in a discharging mode according to a first embodiment of the present disclosure; please refer to FIG. 4B, which shows a flowchart of operating the electric vehicle charger in the discharging mode according to a first embodiment of the present disclosure, and also refer to FIG. 1A to FIG. 3B and with repeated reference to FIG. 4A and FIG. 4B. FIG. 4A mainly illustrates the power path of the vehicle power Pe (i.e., the dashed arrows). Referring to FIG. 4B, when the mains fails (is unavailable) (S300), the control circuit 18 is disabled due to the lack of a power source, forcing the electric vehicle charger 1 to shut down. Furthermore, when the electric vehicle is connected to the electric vehicle charger and the user activates the electric vehicle to discharge (S310), the electric vehicle provides the vehicle power to the vehicle terminal (S320). Since the driving circuit 16 is coupled to the vehicle terminal E2, the driving circuit 16 is activated upon receiving the vehicle power Pe. After the driving circuit is activated (S330), the driving circuit controls the second terminal and the third terminal of the switching switch 12 to be connected, thereby supplying the vehicle power to the auxiliary power circuit (S340). Since the driving circuit 16 controls the second terminal B and the third terminal C of the switching switch 12 to be connected, the vehicle power Pe can be supplied to the auxiliary power circuit 14 through the path from the second terminal B to the third terminal C. The auxiliary power circuit 14 then converts the vehicle power Pe into the auxiliary power Pa, which then activates the control circuit 18. Therefore, the control circuit 18 is activated, and the control circuit 18 determines whether the power source is the supplying power Pg.

When the control circuit is activated and determines that the power source is the vehicle power (S350), the control circuit performs the handshake communication with the electric vehicle (S360). Specifically, when the control circuit 18 is activated and determines that the power source is the vehicle power Pe, the control circuit 18 performs the handshake communication Hs with the electric vehicle 300 through the control pilot terminal CP1. After the handshake communication is completed, the control circuit 18 sets the operating mode of the electric vehicle charger 1 to the discharging mode. In this condition, the control circuit 18 also provides a control signal Sc to control the continuous connection between the second terminal B and the third terminal C of the switching switch 12, thereby continuously receiving the vehicle power Pe through the path from the second terminal B to the third terminal C. In one embodiment, the control signal Sc that controls the connection between the second terminal B and the third terminal C and the control signal Sc that controls the connection between the first terminal A and the third terminal C may have opposite voltage levels (for example, but not limited to, 5V and 0V), but this is not a limitation. They may also be distinguishable signals such as different pulse widths, and are not limited here. Furthermore, the control circuit 18 can perform the handshake communication Hs with the electric vehicle 300 through a communication protocol such as, but not limited to, LIN CP or ISO 15118, which is not limited herein. Finally, the control circuit 18 controls the second switch to be turned on to supply power to the load (S370). That is, the control circuit 18 can control the second switch SW2 to be turned on to short-circuit the path from the electric vehicle 300 to the load 400, thereby supplying power to the load 400 with the vehicle power Pe. Furthermore, since the electric vehicle charging system 100 is mainly suitable for unidirectional power supply systems, when the second switch SW2 is turned on, the control circuit 18 can control the first switch SW1 to be turned off to prevent the vehicle power Pe from being mistakenly supplied to the mains 200 through the first switch SW1 (this is not limited to vehicle-to-mains operation). In particular, there are many ways to short-circuit the path from the electric vehicle 300 to the load 400, and the simplest method of controlling the switch to be turned on is used as an illustrative example, but the present disclosure is not limited to this.

The AC conversion circuit 20 is mainly used to convert the AC vehicle power Pe into AC power suitable for use with the load 400 to meet the power supply requirements of the load 400 (i.e., the AC conversion circuit 20 is an AC-to-AC converter). In one embodiment, the AC conversion circuit 20 is preferably a split-phase conversion circuit. The split-phase conversion circuit mainly converts single-phase power into two-phase or three-phase power, shifting the phase of the input power to create a specific 180-degree phase difference with the original power (i.e., the split-phase conversion circuit mainly converts a single-phase two-wire power into a single-phase three-wire power), but this is not limited to this. Based on actual circuit requirements, it can also provide an adjustable specific phase difference (for example, but not limited to, 60 degrees or 90 degrees) to modulate the phase difference to the desired phase of the load 400 (for example, but not limited to, a quadrature phase suitable for motor starting). Therefore, if the vehicle power Pe is a single-phase AC output, a split-phase conversion circuit can be used to convert the output into two-phase AC power. Therefore, in FIG. 4A and FIG. 4B, the control circuit 18 can control the split-phase conversion circuit (i.e., the AC conversion circuit 20) to split-phase-convert the vehicle power Pe into a first AC power Pac1 and a second AC power Pac2 with a specific phase difference, thereby providing the first AC power Pac1 and the second AC power Pac2 to the load 400 through two live wires L1, L2, respectively, to supply power to the load 400.

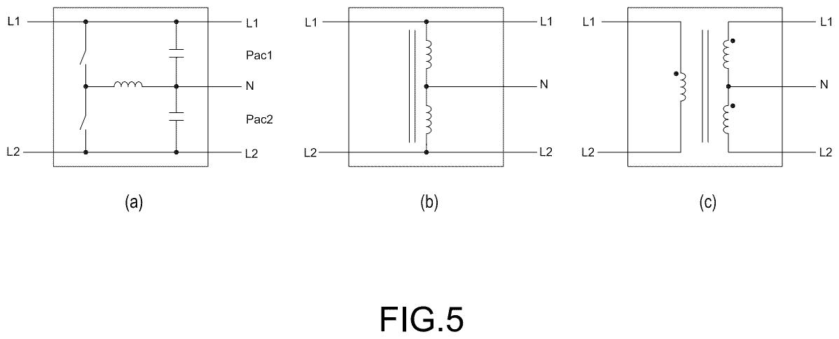

Please refer to FIG. 5, which shows a circuit diagram of an AC conversion circuit according to the present disclosure, and also refer to FIG. 1A to FIG. 4B. In FIG. 5(a), the AC conversion circuit 20 is composed of a split-phase conversion circuit, whose input terminal is a single-phase input structure and includes two live wires L1, L2. Furthermore, the split-phase conversion circuit includes two switches connected in series between the two live wires L1, L2, and two capacitors connected in series between the two live wires L1, L2. A first terminal of the power inductor is coupled to a node between the two switches, and a second terminal of the power inductor is coupled to a node between the two capacitors, forming the neutral wire N. The control circuit 18 controls the switching of the two switches to convert the vehicle power Pe into the first AC power Pac1 and the second AC power Pac2 with a specific phase difference, and the first AC power Pac1 and the second AC power Pac2 are then provided to the load 400 through the two live wires L1, L2 and the neutral wire N, respectively.

In FIG. 5(b), the AC conversion circuit 20 is constructed using an autotransformer, while in FIG. 5(c), the AC conversion circuit 20 is constructed using a transformer. Furthermore, although the vehicle power Pe is coupled through the transformer windings to generate the first AC power Pac1 and the second AC power Pac2 with a phase difference, due to the physical limitations of the transformer, the transformer can only convert AC power with a fixed phase difference of 180 degrees and cannot adaptively adjust the phase difference according to the requirements of the load 400. However, if the phase difference is not necessary and cost savings are not a concern, the structures of FIG. 5(b) and FIG. 5(c) may still serve as the AC conversion circuit 20 of the present disclosure.

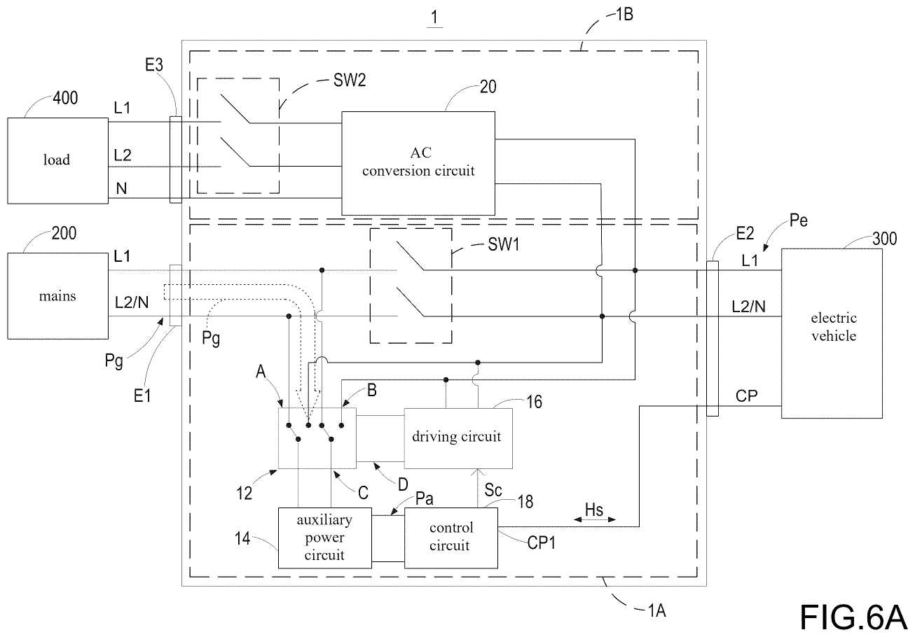

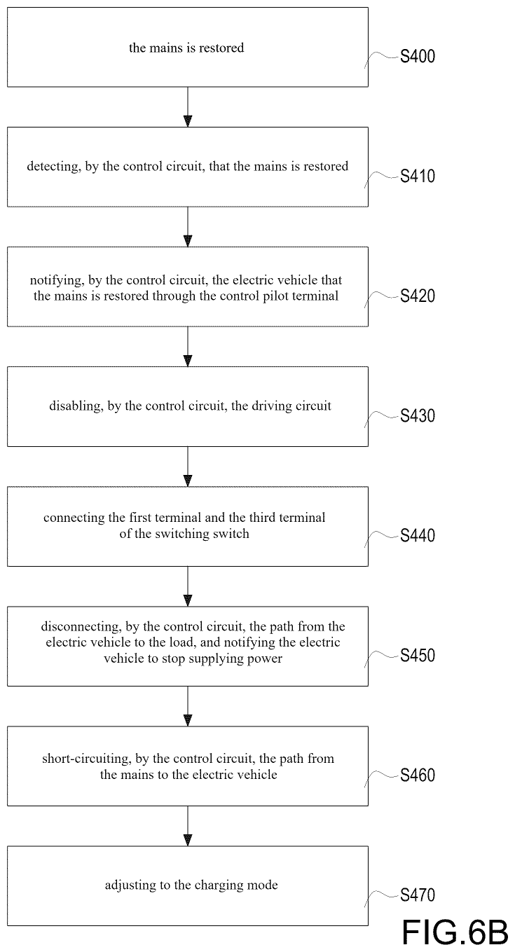

Please refer to FIG. 6A, which shows a power path diagram of the electric vehicle charger when a mains is restored according to a first embodiment of the present disclosure; please refer to FIG. 6B, which shows a flowchart of operating the electric vehicle charger when the mains is restored according to a first embodiment of the present disclosure, and also refer to FIG. 1A to FIG. 5 and with repeated reference to FIG. 6A and FIG. 6B. FIG. 6A mainly illustrates the power flow (i.e., dashed arrows) of the supplying power Pg when the mains 200 is restored. Referring to FIG. 6B, after the electric vehicle 300 provides the vehicle power Pe to supply power to the load 400 and the mains is restored (S400), it indicates that the mains has been restored to an available state. Furthermore, since the control circuit 18 continuously detects whether the mains 200 has been restored in the discharging mode (refer to step S150 in FIG. 2B), when the mains 200 has been restored to an available state, the control circuit detects the restoration of the mains (S410).

When the control circuit 18 detects that the mains 200 has been restored, the control circuit notifies the electric vehicle that the mains is restored through the control pilot terminal (S420) and confirms whether to adjust the operating mode from the discharging mode (discharging the load 400 by the electric vehicle 300) to the charging mode (charging the electric vehicle 300 by the mains 200). Upon receiving the notification from the control pilot terminal CP1, the electric vehicle 300 may proactively stop supplying the vehicle power Pe to the vehicle terminal E2. Alternatively, upon receiving the notification, the electric vehicle 300 may wait for a user action to manually stop discharging the electric vehicle 300. After confirming the subsequent operation procedure, the electric vehicle 300 transmits the information back to the control circuit 18 through the control pilot terminal CP1. In this condition, although the AC supplying power Pg is present at the mains terminal E1, the electric vehicle charger 1 does not take any action on the supplying power Pg since the first switch SW1 is turned off and the first terminal A and the third terminal C of the switching switch 12 are not connected.

Afterward, when the control circuit 18 receives a notification from the electric vehicle 300 to confirm that the operating mode needs to be adjusted from the discharging mode to the charging mode, the control circuit disables the driving circuit (S430). That is, the control circuit 18 provides a control signal Sc to disable the driving circuit 16, thereby causing the switching switch 12 to return to its normally closed state. As a result, the first terminal and the third terminal of the switching switch 12 are connected (S440). When the first terminal A and the third terminal C of the switching switch 12 are connected, the supplying power Pg is supplied to the auxiliary power circuit 14, thereby causing the auxiliary power circuit 14 to convert the supplying power Pg into an auxiliary power Pa, which continues to supply power to the control circuit 18. Afterward, the control circuit disconnects the path from the electric vehicle to the load and notifies the electric vehicle to stop supplying power (S450). That is, the control circuit 18 disconnects the path from the electric vehicle 300 to the load 400 by controlling the second switch SW2 to be turned off. Furthermore, upon receiving the power supply stop notification from the control circuit 18, the electric vehicle 300 stops supplying the vehicle power Pe. After the control circuit 18 confirms that the electric vehicle 300 has stopped supplying the vehicle power Pe, the control circuit short-circuits the path from the mains to the electric vehicle (S460) and switches the operating mode to the charging mode (S470). That is, the control circuit 18 controls the first switch SW1 to be turned on to short-circuit the path from the mains 200 to the electric vehicle 300 and enable the electric vehicle 300 to be charged with the supplying power Pg.

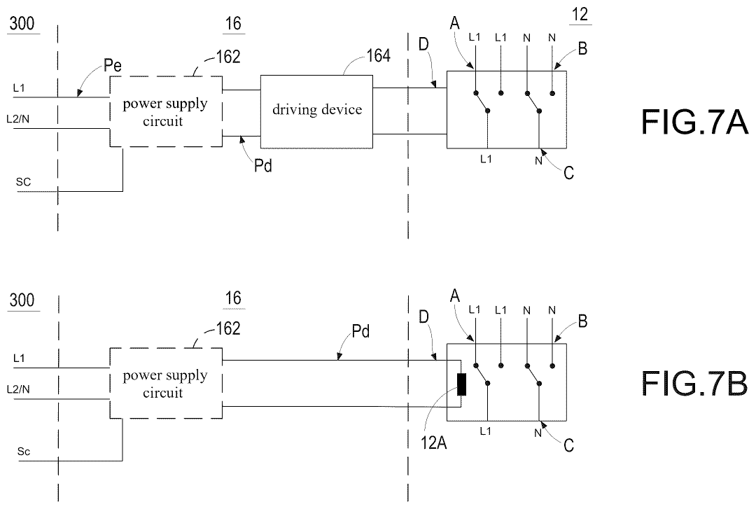

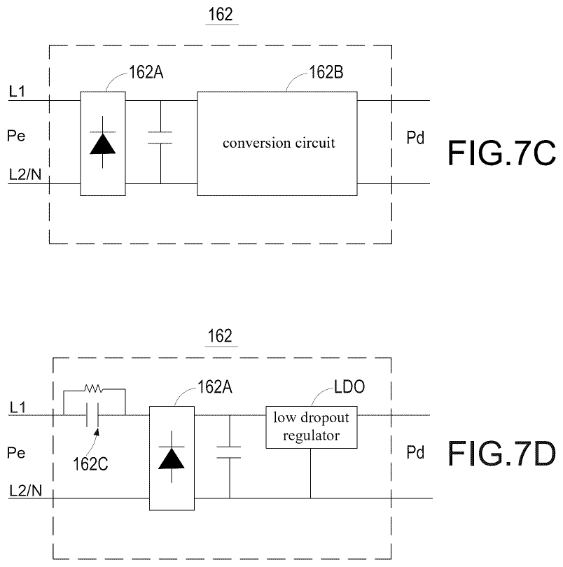

Please refer to FIG. 7A, which shows a block circuit diagram of a driving circuit according to a first embodiment of the present disclosure; please refer to FIG. 7B, which shows a block circuit diagram of the driving circuit according to a second embodiment of the present disclosure, and also refer to FIG. 1A to FIG. 6B. The driving circuit 16 is mainly used to drive the switching switch 12 according to the vehicle power Pe, and the driving circuit 16 includes a power supply circuit 162. The power supply circuit 162 is coupled to the vehicle terminal E2, the control circuit 18, and the control terminal D of the switching switch 12. The power supply circuit 162 selectively converts the vehicle power Pe into the driving power Pd according to a control signal Sc provided by the control circuit 18, thereby controlling the second terminal B and the third terminal C of the switching switch 12 according to the driving power Pd. When the auxiliary power circuit 14 provides the auxiliary power Pa, the control circuit 18 provides a control signal Sc (e.g., but not limited to, 0V) to disable the power supply circuit 162, thereby rendering the power supply circuit 162 inoperative and unable to convert the vehicle power Pe into the driving power Pd. Therefore, the power supply circuit 162 is unable to provide the driving power Pd to cause the switching switch 12 to be normally closed, which the first terminal A and the third terminal C are connected. When the auxiliary power circuit 14 does not provide the auxiliary power Pa and the power supply circuit 162 receives the vehicle power Pe, the control circuit 18 provides a control signal Sc (for example, but not limited to, 5V) to the power supply circuit 162 to enable the power supply circuit 162. Therefore, the power supply circuit 162 converts the vehicle power Pe into the driving power Pd so that the second terminal B and the third terminal C of the switching switch 12 are connected according to driving power Pd. In particular, the control signal Sc provided by the control circuit 18 may be a controller within the control circuit 18 that operates to change a voltage level (for example, but not limited to, a high level of 5V or a low level of 0V). Alternatively, the control circuit 18 may include a predetermined ground (for example, a resistor connected to ground) to provide a low level of 0V, which is not limited here.

Specifically, in FIG. 7A, the switching switch 12 is a switch device that requires a switch driver to operate. Therefore, the driving circuit 16 includes a driving device 164 serving as a switch driver. The driving device 164 is coupled to the power supply circuit 162 and the control terminal D of the switching switch 12. When the power supply circuit 162 is inoperative and unable to convert the vehicle power Pe into the driving power Pd, the driving device 164, without receiving the driving power Pd, is unable to drive the switching switch 12 through the control terminal D. Consequently, the switching switch 12 is in a normally closed state, which the first terminal A and the third terminal C are connected. Conversely, when the power supply circuit 162 converts the vehicle power Pe into the driving power Pd, the driving device 164, receiving the driving power Pd, drives the switching switch 12 through the control terminal D so that the second terminal B and the third terminal C of the switching switch 12 are connected.

In FIG. 7B, the switching switch 12 is an electromagnetic switch with an excitation coil 12A. Therefore, the power supply circuit 162 is coupled to the control terminal D so as to be coupled to the excitation coil 12A within the switching switch 12 through the control terminal D. When the power supply circuit 162 is inoperative and unable to convert the vehicle power Pe into the driving power Pd, the control terminal D, without receiving the driving power Pd, prevents the excitation coil 12A from being energized to cause the switching switch 12 to be normally closed, which the first terminal A and the third terminal C are connected. Conversely, when the power supply circuit 162 converts the vehicle power Pe into the driving power Pd, the control terminal D, receiving the driving power Pd, energizes the excitation coil 12A, attracting the contacts of the switching switch 12 and connecting the second terminal B and the third terminal C. In particular, in one embodiment, FIG. 7A and FIG. 7B are merely schematic examples of the driving circuit 16, and its internal configuration can be adjusted according to the type of the switching switch 12, and is not limited to the structures of FIG. 7A and FIG. 7B.

Please refer to FIG. 7C, which shows a block circuit diagram of a power supply circuit according to a first embodiment of the present disclosure; please refer to FIG. 7D, which shows a block circuit diagram of the power supply circuit according to a second embodiment of the present disclosure, and also refer to FIG. 1A to FIG. 7B. In FIG. 7C, the power supply circuit 162 may be an AC-to-DC converter consisting of a rectifying circuit 162A and a conversion circuit 162B. Its primary function is to step down the AC vehicle power Pe into a DC driving power Pd. Since the vehicle power Pe is generally high-voltage power, and the switching switch 12 is generally driven by low voltage power, it is preferable for the conversion circuit 162B to be an isolated converter with a transformer. In FIG. 7D, the power supply circuit 162 may be implemented as an RC step-down power source 162C. Specifically, the power supply circuit 162 may be an AC-to-DC converter consisting of an RC step-down power source 162C, a rectifying circuit 162A, and a low dropout regulator (LDO). This converter also steps down the AC vehicle power Pe into a DC driving power Pd. Furthermore, the RC step-down power source 162C is more suitable for lower-power applications, resulting in higher efficiency. In particular, FIG. 7C and FIG. 7D are merely schematic illustrations of power supply circuit 162. Its internal configuration can be adjusted based on the characteristics of AC-to-DC conversion and is not limited to the structures shown in FIG. 7C and FIG. 7D.

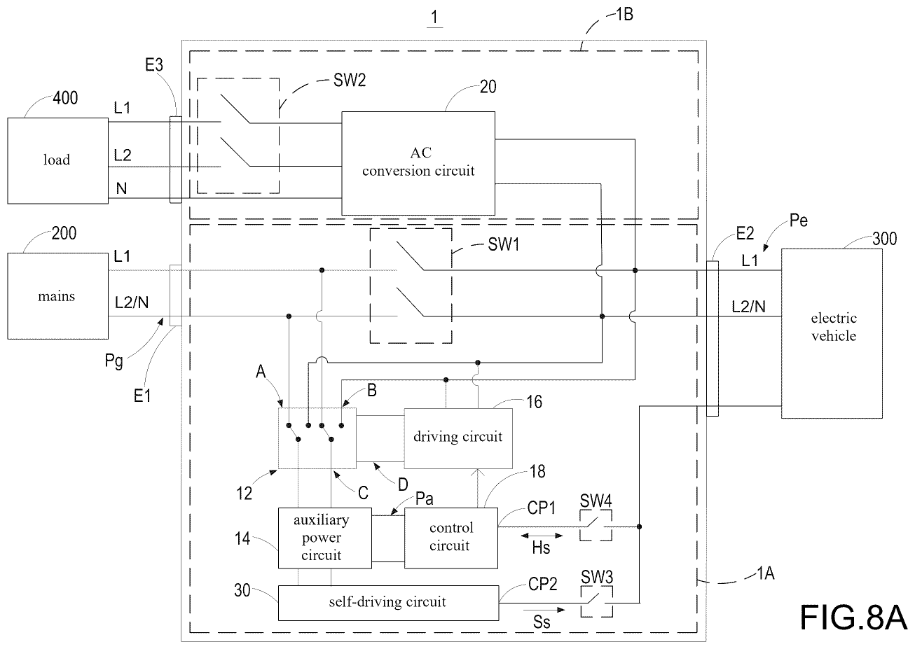

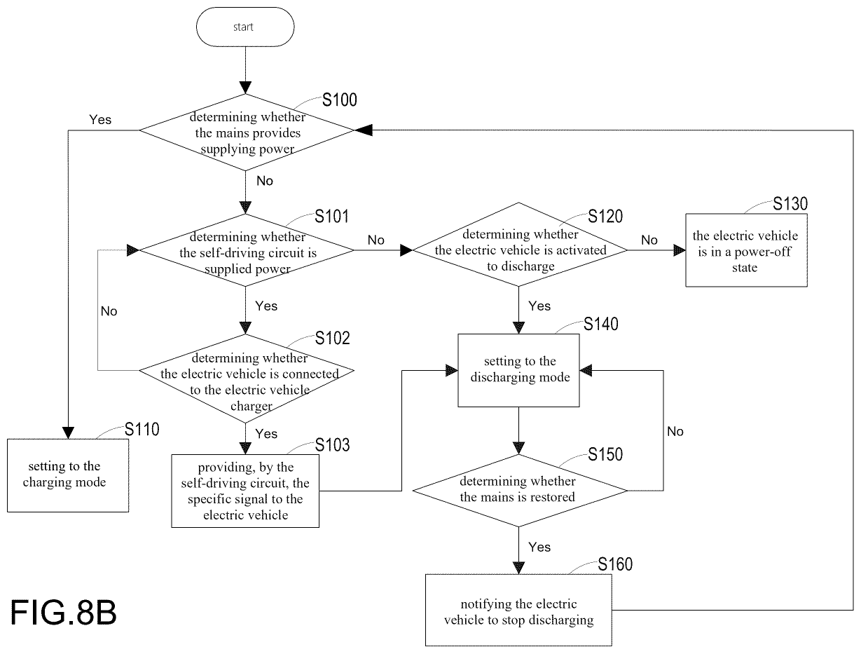

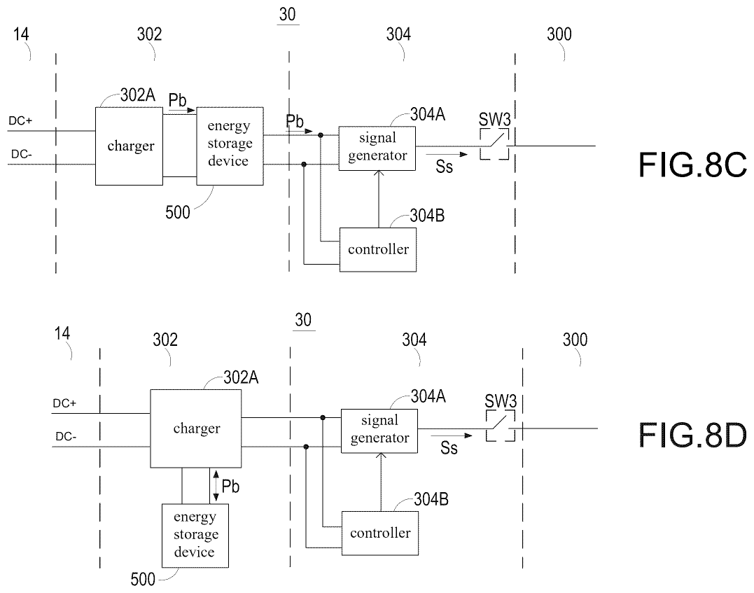

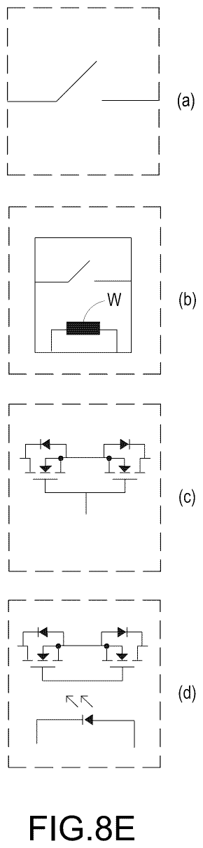

Please refer to FIG. 8A, which shows a block circuit diagram of the electric vehicle charger according to a second embodiment of the present disclosure; please refer to FIG. 8A, which shows a flowchart of operating the electric vehicle charger according to a second embodiment of the present disclosure, and also refer to FIG. 1A to FIG. 7D. FIG. 8A mainly utilizes the self-driving circuit 30 within the electric vehicle charger 1 to enable the discharging function of the electric vehicle 300 and subsequently enter the discharging mode. Specifically, FIG. 2A mainly utilizes the characteristics set by the electric vehicle 300 to enable the discharging function of the electric vehicle 300 when the control circuit 18 is disabled. FIG. 2A mainly provides an alternative operating method to enable the discharging function of the electric vehicle 300 when the control circuit 18 is disabled. Furthermore, FIG. 8A differs from FIG. 2A in that the electric vehicle charger 1 of FIG. 8A includes the self-driving circuit 30. The self-driving circuit 30 includes a control pilot terminal CP2, which is coupled to the onboard charger of the electric vehicle 300 through the vehicle terminal E2. This allows the onboard charger of the electric vehicle 300 to receive a signal from the control pilot terminal CP2 when the electric vehicle 300 is connected to the electric vehicle charger 1. Therefore, when the mains 200 fails and the electric vehicle 300 is connected to the vehicle terminal E2, the self-driving circuit 30 provides a specific signal Ss to the electric vehicle 300 through the control pilot terminal CP2, thereby notifying the electric vehicle 300 to provide vehicle power Pe through the specific signal Ss.

In one embodiment, the electric vehicle charger 1 can proactively provide a specific signal Ss to the electric vehicle 300 when the electric vehicle 300 is coupled to the vehicle terminal E2. Alternatively, the electric vehicle charger 1 can also be manually operated by the user to provide the specific signal Ss. In another embodiment, the specific signal Ss is, for example, but not limited to, a pulse signal having a specific frequency (for example, but not limited to, a signal with 166 Hz, which is mainly a signal with a specific function defined in SAE J2847-5 Table 1), but is not limited thereto. Furthermore, when the control circuit 18 performs the handshake communication Hs with the electric vehicle 300 through the control pilot terminal CP1, a pulse signal with 1 kHz is typically used for the handshake communication Hs. Therefore, the specific signal Ss for notifying the electric vehicle 300 to discharge the battery needs to be different from the handshake communication Hs to avoid misjudgment by the electric vehicle 300. Furthermore, the specific signal Ss may be set according to the specifications of the electric vehicle 300 so that the electric vehicle 300 can recognize the signal that discharge is required, and is therefore not limited to a pulse signal of a specific frequency.

Referring to FIG. 8A again, a third switch SW3 may be included between the control pilot terminal CP2 of the self-driving circuit 30 and the vehicle terminal E2, and a fourth switch SW4 may be included between the control pilot terminal CP1 of the control circuit 18 and the vehicle terminal E2. The third switch SW3 and the fourth switch SW4 are mainly used to shut down the transmission path of one of the control pilot terminals CP1, CP2 when the other transmits a signal, thereby preventing signal contamination and misjudgment by the electric vehicle 300. Therefore, when the mains 200 fails, the third switch SW3 is turned on and the fourth switch SW4 is turned off. When the electric vehicle 300 is coupled to the vehicle terminal E2, the electric vehicle charger 1 short-circuits a first communication path from the self-driving circuit 30 to the electric vehicle 300 by turning on the third switch SW3, and disconnects a second communication path from the control circuit 18 to the electric vehicle 300, thereby allowing the specific signal Ss to be provided to the vehicle terminal E2 through the third switch SW3. On the contrary, when the control circuit 18 is enabled and operates normally, the control circuit 18 controls the third switch SW3 to be turned off and controls the fourth switch SW4 to be turned on to short-circuit the second communication path and disconnect the first communication path so that the control circuit 18 can perform the handshake communication Hs with the electric vehicle 300 through the second communication path.

In particular, in one embodiment, when the mains 200 fails, the control circuit 18 loses power and cannot control the third switch SW3 and the fourth switch SW4. Therefore, the third switch SW3 is preferably a normally closed (NC) switch, meaning it is in a turned-on state under normal and uncontrolled conditions. Also, the fourth switch SW4 is preferably a normally open (NO) switch, meaning it is in a turned-off state under normal and uncontrolled conditions. Therefore, even when the control circuit 18 loses power, the specific signal Ss can still be provided to the vehicle terminal E2 through the normally closed third switch SW3, however, this is not a limitation. For example, but not limited to, the third switch SW3 can be supplied power and controlled by the self-driving circuit 30. Even when the control circuit 18 loses power, it can be driven by external power and external control (the same applies to the fourth switch SW4, which will not be discussed here). Furthermore, in one embodiment, the circuit structure and operation method not described in FIG. 8A are similar to those in FIG. 2A and will not be described in detail herein.

Referring to FIG. 2B and FIG. 8B, the difference between FIG. 8B and FIG. 2B lies in the additional operational flow between steps S100 to S120 in FIG. 8B due to the addition of the self-driving circuit 30. Specifically, after determining in step S100 of FIG. 8B that the mains 200 does not provide the supplying power Pg, the self-driving circuit is determined to be supplied power (S101). If the self-driving circuit 30 is not supplied power, it cannot provide a specific signal Ss to notify the electric vehicle 300 to discharge, and therefore the process proceeds to step S110 of FIG. 2B. Conversely, if the self-driving circuit 30 is supplied power, it determines whether the electric vehicle is connected to the electric vehicle charger (S102). If the electric vehicle 300 is not connected to the electric vehicle charger 1, the process returns to step S101 for continued confirmation. If not, the self-driving circuit provides a specific signal to the electric vehicle (S103) to notify the electric vehicle 300 to provide the vehicle power Pe. Specifically, the electric vehicle charger 1 can proactively provide a specific signal Ss to the electric vehicle 300 when the electric vehicle 300 is coupled to the vehicle terminal E2. Alternatively, when the electric vehicle 300 is coupled to the electric vehicle charger 1, the electric vehicle charger 1 can be manually operated by the user to provide the specific signal Ss. After receiving the specific signal Ss, the electric vehicle 300 proceeds to step S140 in FIG. 2B to enter the discharging mode.

Please refer to FIG. 8C, which shows a block circuit diagram of a self-driving circuit according to a first embodiment of the present disclosure; please refer to FIG. 8D, which shows a block circuit diagram of the self-driving circuit according to a second embodiment of the present disclosure, and also refer to FIG. 1A to FIG. 8B. FIG. 8C and FIG. 8D are circuit block diagrams of two possible implementations of the self-driving circuit 30, and the primary difference between them lies in the structure of the power supply device 302. Specifically, the self-driving circuit 30 includes a power supply device 302 and a signal generation circuit 304. The power supply device 302 is configured to provide the energy storage power Pb. The signal generation circuit 304 is coupled to the power supply device 302 and is configured to provide a specific signal Ss according to the energy storage power Pb. When the electric vehicle 300 is coupled to the vehicle terminal E2, the signal generation circuit 304 provides a specific signal Ss to the vehicle terminal E2 according to the energy storage power Pb.

In particular, in one embodiment, the power supply device 302 may be coupled to the auxiliary power circuit 14 to provide the energy storage power Pb according to the auxiliary power Pa. Specifically, the self-driving circuit 30 can include or be connected to a replaceable energy storage device 500, which can be rechargeable or non-rechargeable. If the self-driving circuit 30 includes or is connected to a non-rechargeable energy storage device 500, when the energy storage power Pb of the energy storage device 500 is out of power, the energy storage device 500 can be replaced by another energy storage device 500 to enable it to provide the energy storage power Pb again. Conversely, if the self-driving circuit 30 includes or is connected to a rechargeable energy storage device 500, the power supply device 302 can be coupled to the auxiliary power circuit 14 to charge the energy storage device 500 by using the auxiliary power Pa. In one embodiment, the energy storage device 500 may be, for example, but not limited to, a battery, a lead-acid battery, a supercapacitor, or other device capable of storing electricity, and is not limited herein.

If the self-driving circuit 30 includes or is connected to a rechargeable energy storage device 500, when the auxiliary power circuit 14 provides auxiliary power Pa and the power supply device 302 has a charging request, the power supply device 302 can convert the auxiliary power Pa into the energy storage power Pb to charge the energy storage device 500. Conversely, when the auxiliary power circuit 14 does not provide the auxiliary power Pa and the electric vehicle 300 is coupled to the vehicle terminal E2, the signal generation circuit 304 provides a specific signal Ss to the vehicle terminal E2 according to the energy storage power Pb.

Specifically, referring to FIG. 8C, the power supply device 302 includes a charger 302A, and the signal generation circuit 304 includes a signal generator 304A and a controller 304B. The energy storage device 500 is coupled to the charger 302A and the signal generator 304A, and the controller 304B is coupled to the signal generator 304A. In FIG. 8C, the charger 302A is preferably a unidirectional charger so that after charging the energy storage device 500, the energy storage device 500 does not discharge through the charger 302A. Therefore, when the auxiliary power circuit 14 provides the auxiliary power Pa and the power supply device 302 needs to be charged, the charger 302A can convert the auxiliary power Pa into the energy storage power Pb to charge the energy storage device 500. Furthermore, when the auxiliary power circuit 14 does not provide the auxiliary power Pa and the electric vehicle 300 is coupled to the vehicle terminal E2, the controller 304B controls the signal generator 304A to generate a specific signal Ss (such as but not limited to a signal with 166 Hz) to the vehicle terminal E2.

On the other hand, the difference between FIG. 8D and FIG. 8C is that the charger 302A may be a bidirectional-charging charger. Therefore, when the energy storage device 500 requires charging, the charger 302A can convert the auxiliary power Pa into the energy storage power Pb to charge the energy storage device 500. Furthermore, when the electric vehicle 300 is connected to the vehicle terminal E2, the charger 302A can convert the energy storage power Pb provided by the energy storage device 500 to supply power to the signal generation circuit 304. Therefore, the controller 304B can control the signal generator 304A to generate a specific signal Ss (for example, but not limited to, a signal with 166 Hz) to the vehicle terminal E2. In particular, in one embodiment, the circuit structure and operation not described in FIG. 8D are similar to those in FIG. 8C and will not be further described here.

Please refer to FIG. 8E, which shows a schematic diagram of a circuit structure in which a third switch and a fourth switch according to the present disclosure, and also refer to FIG. 1A to FIG. 2B. FIG. 8E(a) to FIG. 8E(d) mainly illustrate circuit structures that can be implemented for the third switch SW3 and the fourth switch SW4. For example, in FIG. 8E(a), the electric vehicle charger 1 may use relays as the third switch SW3 and the fourth switch SW4. In FIG. 8E(b), the electric vehicle charger 1 can use contactors as the third switch SW3 and the fourth switch SW4, which can generate a magnetic field by flowing current through a coil W to close the contacts. In FIG. 8E(c), the electric vehicle charger 1 can use back-to-back MOSFETs as the third switch SW3 and the fourth switch SW4, thereby enabling bidirectional switching to disconnect the power path. In FIG. 8E(d), the electric vehicle charger 1 can use photocoupler relays as the third switch SW3 and the fourth switch SW4, thereby enabling on/off control through optocoupler isolation. Therefore, in summary, the present disclosure does not limit the specific circuit structure used by the third switch SW3 and the fourth switch SW4. As long as the circuits and electronic components can achieve the bidirectional turned-off function, they should be included in the scope of this embodiment.

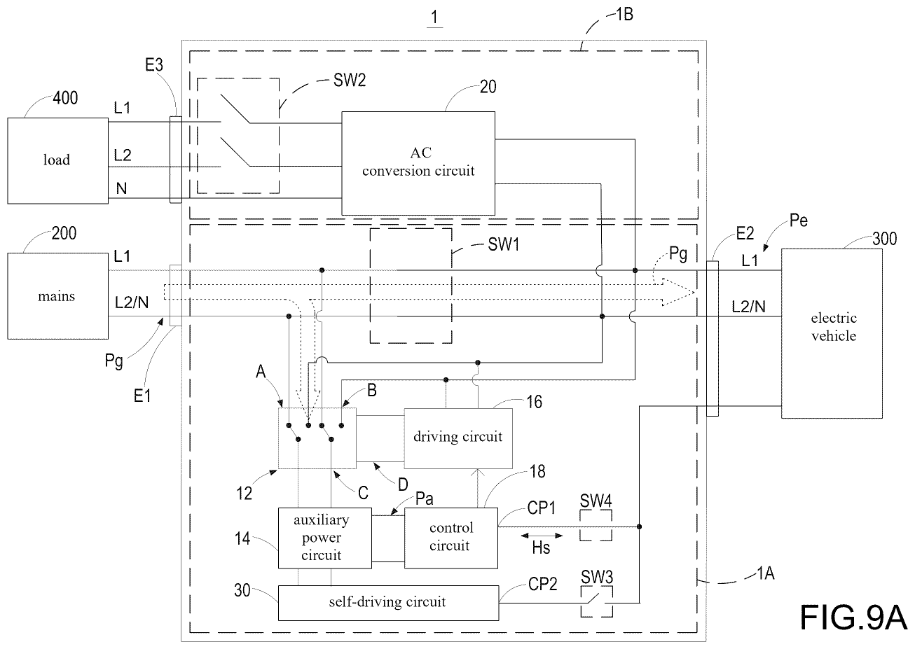

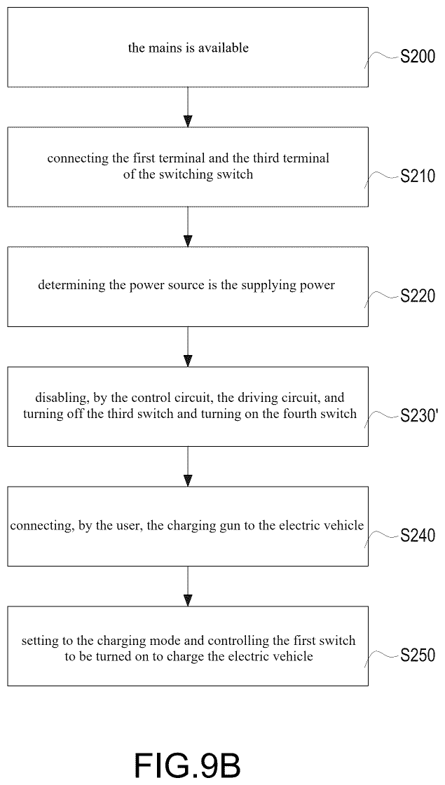

Please refer to FIG. 9A, which shows a power path diagram of the electric vehicle charger in the charging mode according to a second embodiment of the present disclosure; please refer to FIG. 9B, which shows a flowchart of operating the electric vehicle charger in the charging mode according to a second embodiment of the present disclosure, and also refer to FIG. 1A to FIG. 8D and with repeated reference to FIG. 3A, FIG. 3B, FIG. 9A, and FIG. 9B. The circuit structures of FIG. 3A and FIG. 9A are similar, with the primary difference being that FIG. 9A includes a self-driving circuit 30. Furthermore, the power paths of both in charging mode are identical and will not be further described here. On the other hand, the operating methods of FIG. 3B and FIG. 9B are similar, with the primary difference being that FIG. 9B includes a third switch SW3 and a fourth switch SW4 (see FIG. 9A) in the operating flow, and therefore, step S230 of FIG. 3B has been slightly adjusted. Specifically, after step S220 in FIG. 9B, the control circuit disables the driving circuit and controls the third switch to be turned off and the fourth switch to be turned on (S230′), thereby enabling the handshake communication Hs between the control circuit 18 and the electric vehicle 300 through the second communication path. Furthermore, the circuit structures and operations not described in FIG. 9A and FIG. 9B are similar to those in FIG. 3A and FIG. 3B and will not be further described here.

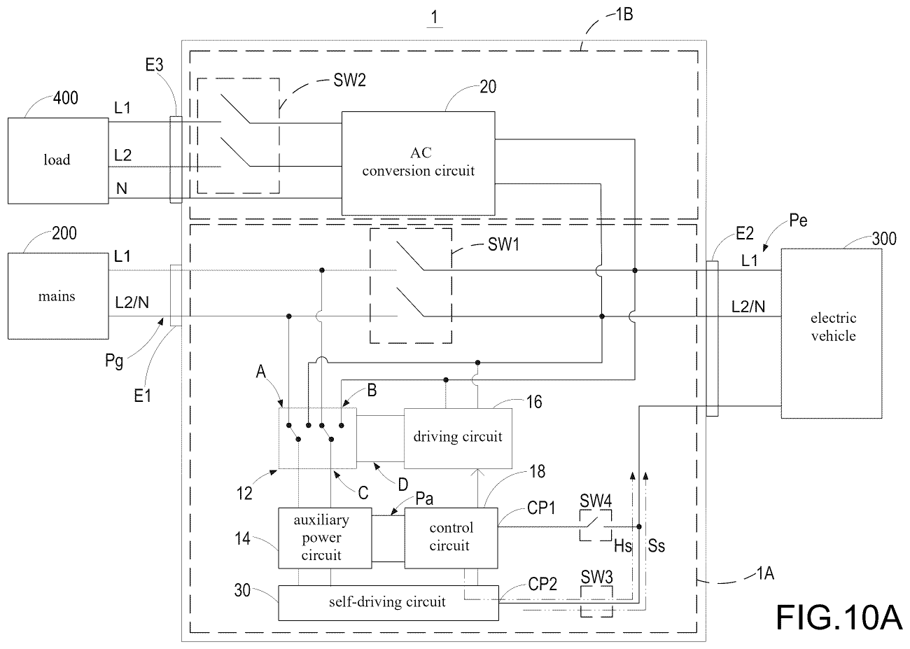

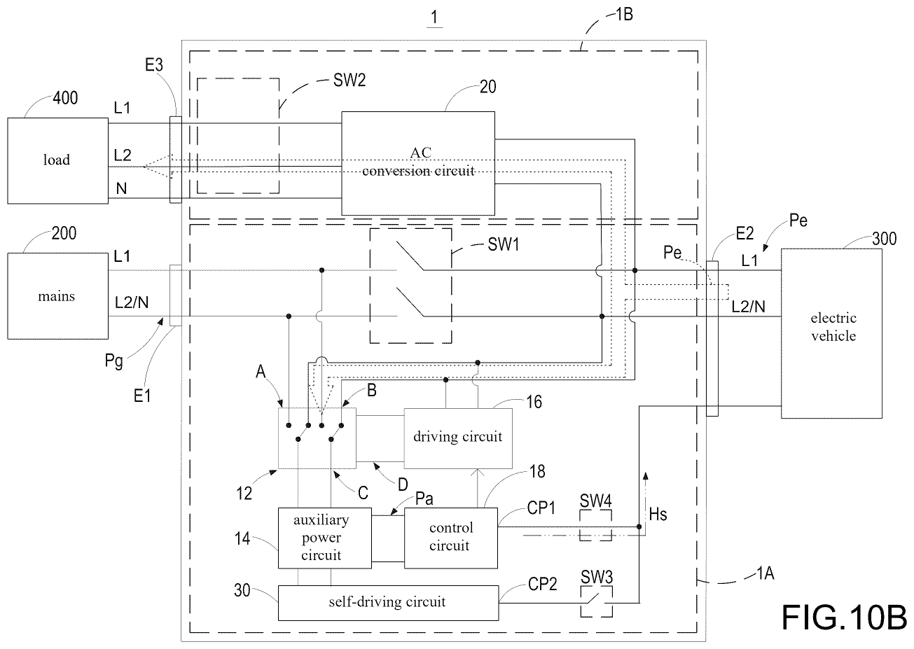

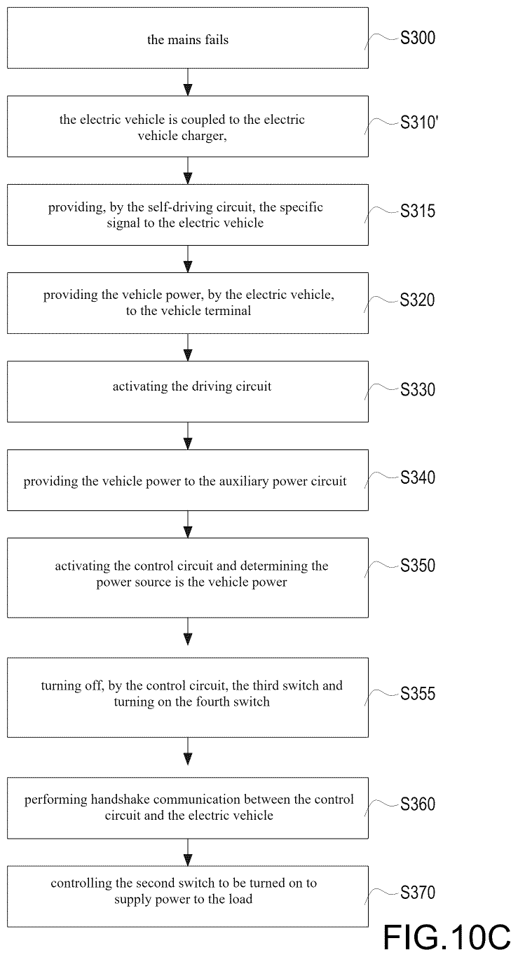

Please refer to FIG. 10A, which shows a power path diagram of the electric vehicle charger when the mains fails, the self-driving circuit has power, and the electric vehicle is coupled according to a second embodiment of the present disclosure; please refer to FIG. 10B, which shows power path diagram of the electric vehicle charger when the self-driving circuit has power to enter the discharging mode according to a second embodiment of the present disclosure; please refer to FIG. 10C, which shows a flowchart of operating the electric vehicle charger in the discharging mode according to a second embodiment of the present disclosure, and also refer to FIG. 1A to FIG. 9B and with repeated reference to FIG. 4A, FIG. 4B, FIG. 10A, FIG. 10B, and FIG. 10C. The circuit structures of FIG. 4A and FIG. 10A and FIG. 10B are similar, the main difference being that FIG. 10A and FIG. 10B include the self-driving circuit 30. Furthermore, FIG. 10A illustrates the operating state of the electric vehicle charger 1 after the mains 200 fails and the self-driving circuit 30 is supplied power. Specifically, after the mains 200 fails and the self-driving circuit 30 is supplied power, the third switch SW3 is turned on and the fourth switch SW4 is turned off. Therefore, the specific signal Ss from the self-driving circuit 30 can be provided to the vehicle terminal E2 through the third switch SW3. When the electric vehicle 300 is coupled to the electric vehicle charger 1, the electric vehicle 300 can receive the specific signal Ss provided by the vehicle terminal E2. On the other hand, FIG. 10B shows the power flow diagram after the electric vehicle 300 is coupled, and the control circuit 18 operates normally according to the vehicle power Pe, and then adjusts the operating mode to the discharging mode. Therefore, the circuit operation of the electric vehicle charger 1 after the mains 200 fails and the operating mode is adjusted to the discharging mode is shown in FIG. 10A and FIG. 10B.

Refer to FIG. 10C, which is a flowchart corresponding to the circuit operation of FIG. 10A and FIG. 10B. Specifically, the circuit operations of FIG. 10A may be referred to in conjunction with steps S300 to S315 of FIG. 10C, and the circuit operations of FIG. 10B may be referred to in conjunction with steps S320 to S370 of FIG. 10C. Specifically, referring to FIG. 4B and FIG. 10C, the difference in the operation process between the two is mainly due to the circuit action related to the self-driving circuit 30 in FIG. 10A and FIG. 10B. Therefore, with the exception of steps S310′, S315, and S355, the operational flows of FIG. 10C are identical to those of FIG. 4B and will not be further described here. Furthermore, after step S300 of FIG. 10C, and when the electric vehicle is connected to the electric vehicle charger (S310′), the self-driving circuit provides a specific signal to the electric vehicle (S315). Before the self-driving circuit 30 provides the specific signal Ss, the third switch SW3 is turned on and the fourth switch SW4 is turned off. Furthermore, the self-driving circuit 30 can provide the specific signal Ss due to power supplied by the energy storage device 500. Therefore, when the electric vehicle 300 is coupled to the electric vehicle charger 1, the specific signal Ss can be provided to the electric vehicle 300 through the vehicle terminal E2, and the process proceeds to step S320 in FIG. 10C.

Afterward, after step S350 in FIG. 10C, the control circuit 18 is activated and can begin the handshake communication Hs with the electric vehicle 300, and two different handshake communication modes are possible. Specifically, referring to FIG. 10B, after step S350, the control circuit controls the third switch to be turned off and the fourth switch to be turned on (S355), thereby enabling the control circuit 18 to handshake communicate Hs with the electric vehicle 300 through the second communication path. On the other hand, referring to FIG. 10A, the control circuit 18 may be coupled to the self-driving circuit 30. Therefore, after step S350, the control circuit 18 can maintain the third switch SW3 to be turned on and the fourth switch SW4 to be turned off, thereby allowing the handshake communication Hs provided by the control circuit 18 to be provided to the electric vehicle 300 through the path through the self-driving circuit 30 and the third switch SW3. That is, in the discharging mode, the electric vehicle charger 1 always handshake communicates Hs with the electric vehicle 300 through the path of the third switch SW3. Furthermore, if the electric vehicle charger 1 has the structure shown in FIG. 10A, step S355 may be skipped and step S360 may be directly entered. Furthermore, the circuit structures and operations not described in FIG. 10A, FIG. 10B, and FIG. 10C are similar to those in FIG. 4A and FIG. 4B and will not be further described here.

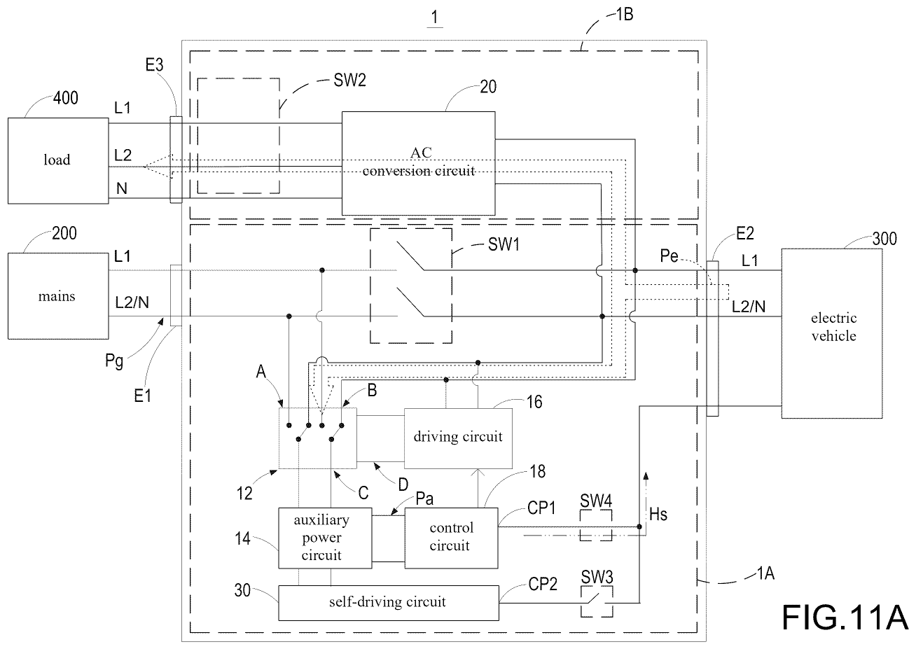

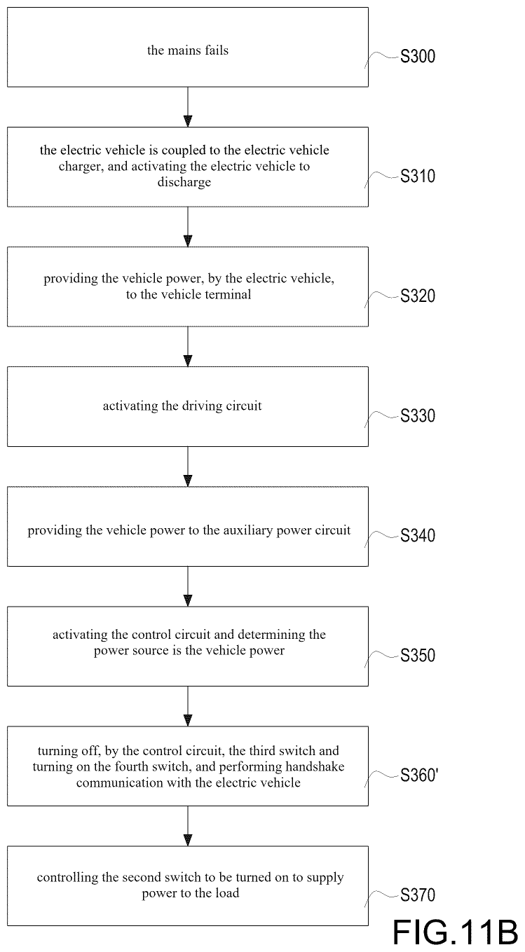

Please refer to FIG. 11A, which shows a power path diagram of the electric vehicle charger when the mains fails and the self-driving circuit has no power to enter the discharging mode according to a second embodiment of the present disclosure; please refer to FIG. 11B, which shows a flowchart of operating the electric vehicle charger when the self-driving circuit has no power and in the discharging mode according to a second embodiment of the present disclosure, and also refer to FIG. 1A to FIG. 10C and with repeated reference to FIG. 4A, FIG. 4B, FIG. 11A, and FIG. 11B. The difference between FIG. 11A and FIG. 11B and FIG. 10A to FIG. 10C is that FIG. 11A and FIG. 11B assume that the energy storage device 500 within the self-driving circuit 30 is out of power, thereby causing the self-driving circuit 30 to fail. Therefore, the circuit structure and operating flow are similar to those of FIG. 4A and FIG. 4B, differing only in that the control circuit 18 can control the third switch SW3 and the fourth switch SW4 after activation. In FIG. 11A, in the discharge mode, the control circuit 18 and the electric vehicle 300 perform the handshake communication Hs, and therefore the fourth switch SW4 is turned on and the third switch SW3 is turned off so that the control circuit 18 and the electric vehicle 300 perform the handshake communication Hs through the fourth switch SW4.

Furthermore, after step S350 in FIG. 11B, an additional operation flow for the self-driving circuit 30 is provided. That is, after step S350, the control circuit controls the third switch to be turned off and the fourth switch to be turned on to perform the handshake communication with the electric vehicle (S360′). Since the control circuit 18 has been activated and can begin the handshake communication Hs with the electric vehicle 300 during step S350, the control circuit 18 controls the third switch SW3 to be turned off and the fourth switch SW4 to be turned on, thereby enabling the control circuit 18 to perform the handshake communication Hs with the electric vehicle 300 through the second communication path. Furthermore, the circuit structure and operation not illustrated in FIG. 11A and FIG. 11B are similar to those in FIG. 4A and FIG. 4B and will not be further described here.

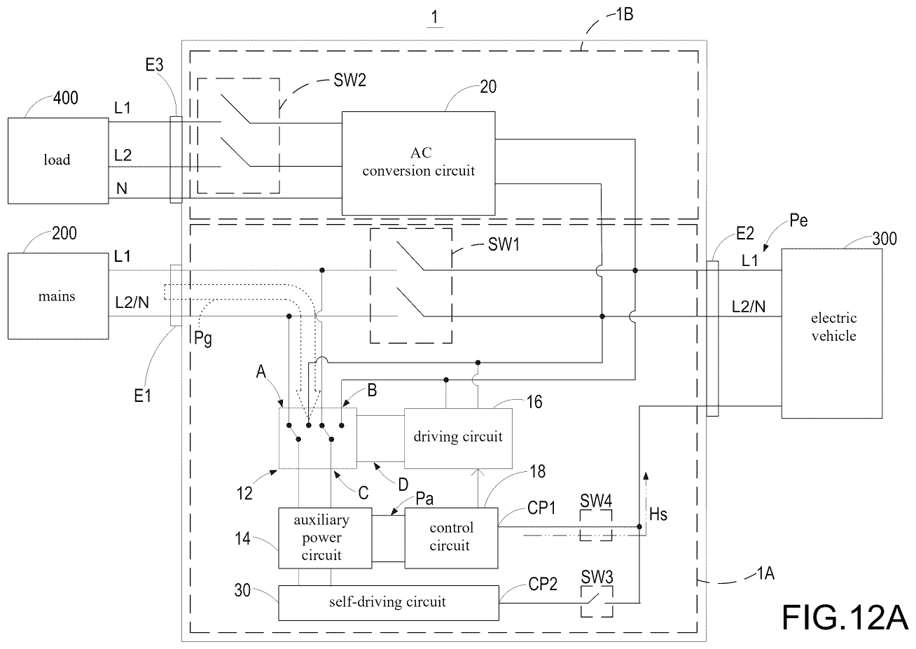

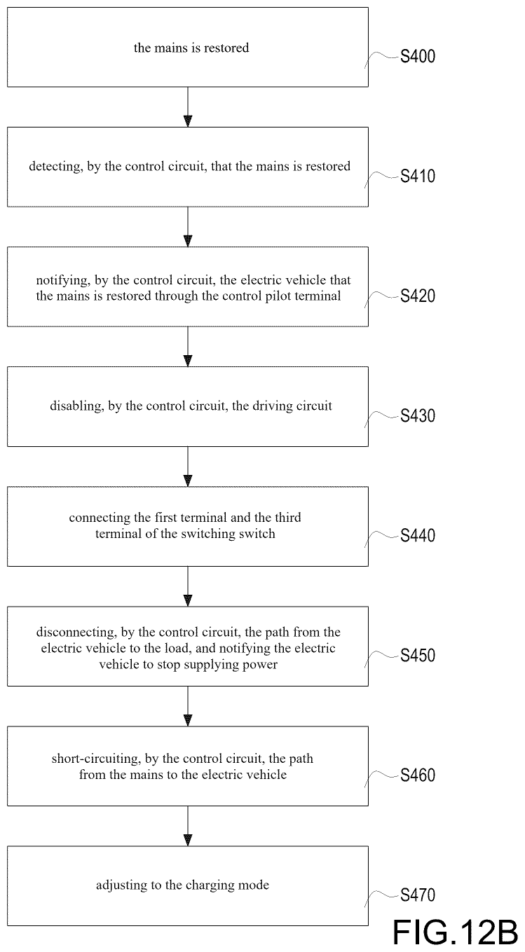

Please refer to FIG. 12A, which shows a power path diagram of the electric vehicle charger when the mains is restored according to a second embodiment of the present disclosure; please refer to FIG. 12B, which shows a flowchart of operating the electric vehicle charger when the mains is restored according to a second embodiment of the present disclosure, and also refer to FIG. 1A to FIG. 11B and with repeated reference to FIG. 6A, FIG. 6B, FIG. 12A, and FIG. 12B. The circuit structures of FIG. 6A and FIG. 12A are similar, the primary difference being that FIG. 12A includes a self-driving circuit 30. Furthermore, the power paths of both devices in charging mode are identical and will not be further described here. Furthermore, the operating methods of FIG. 6B and FIG. 12B are identical. Therefore, the circuit structure and operating methods not described in FIG. 12A and FIG. 12B are similar to those of FIG. 6A and FIG. 6B and will not be further described here.

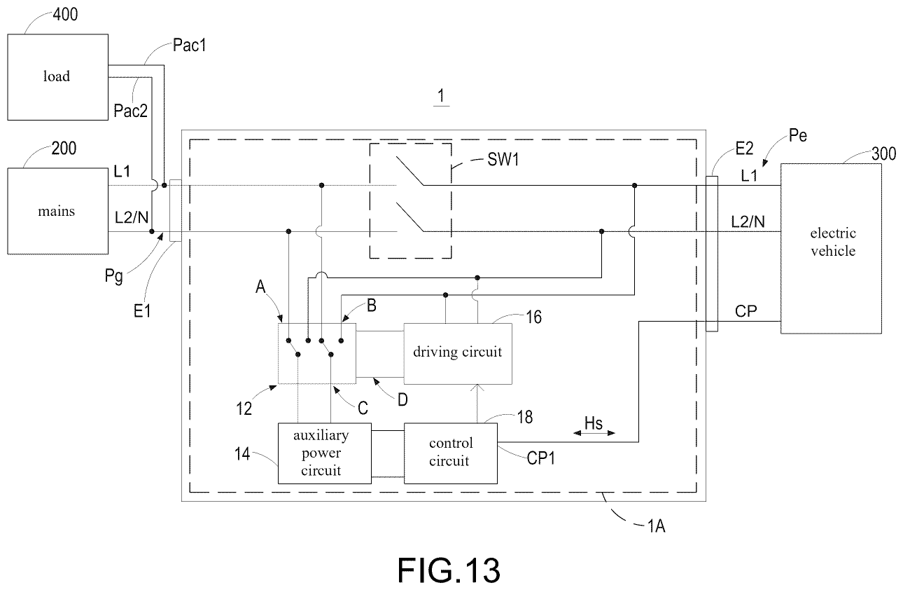

Please refer to FIG. 13, which shows a block circuit diagram of the electric vehicle charger according to a third embodiment of the present disclosure, and also refer to FIG. 1A to FIG. 12B and with repeated reference to FIG. 1B, FIG. 2A, and FIG. 13. The difference between FIG. 13 and FIG. 2A is that FIG. 13 does not include the discharging circuit 1B, and therefore the circuit structure of FIG. 13 does not include the second switch SW2 and the AC conversion circuit 20. Furthermore, the operating method flow of the electric vehicle charger 1 in FIG. 13 is the same as that shown in FIG. 2B and will not be further described here. Therefore, when the control circuit 18 is enabled (i.e., in normal operation), the control circuit 18 can control the first switch SW1, the switching switch 12, the auxiliary power circuit 14, and the driving circuit 16 to control the electric vehicle charger 1 to provide the supplying power Pg to charge the electric vehicle 300 or to provide the vehicle power Pe to discharge the load 400. In particular, in one embodiment, the circuit structure, coupling relationship, and operating method not described in FIG. 13 may also refer to FIG. 2A and FIG. 2B, and will not be further described here.

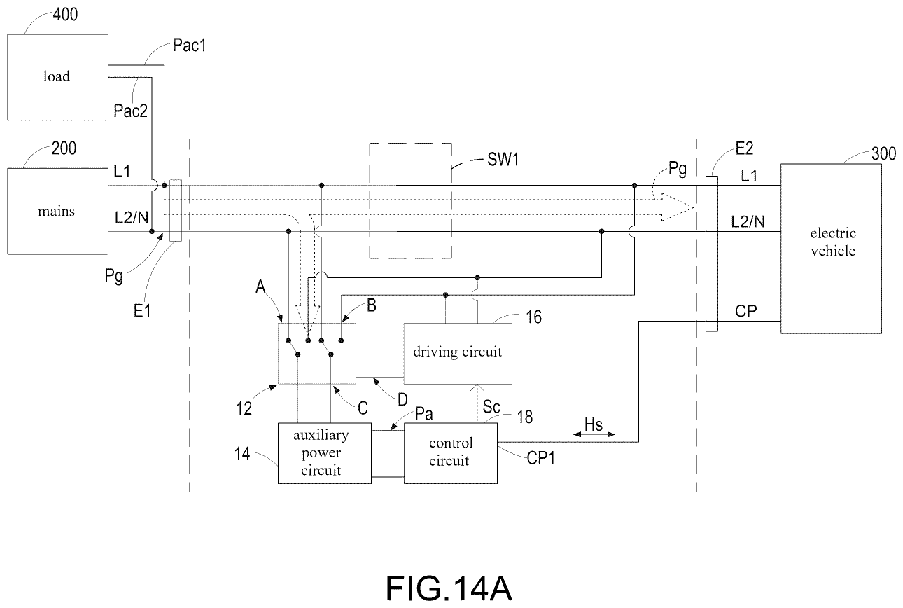

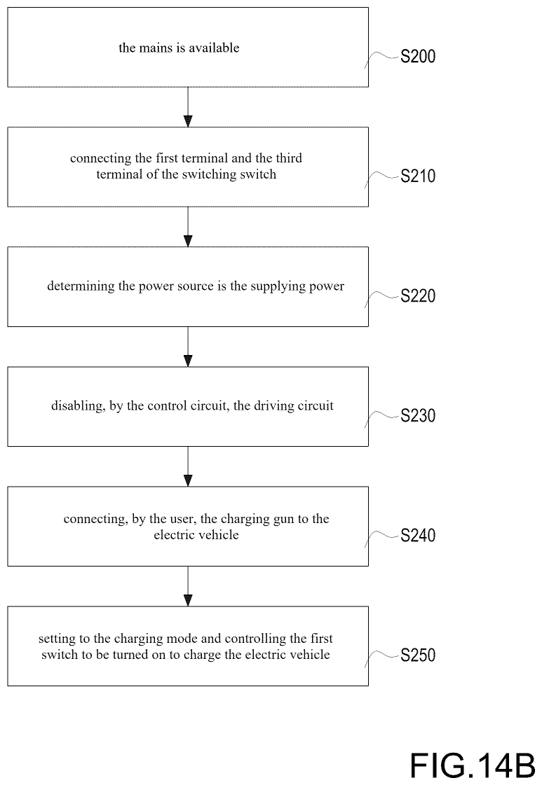

Please refer to FIG. 14A, which shows a power path diagram of the electric vehicle charger in the charging mode according to a third embodiment of the present disclosure; please refer to FIG. 14B, which shows a flowchart of operating the electric vehicle charger in the charging mode according to a third embodiment of the present disclosure, and also refer to FIG. 1A to FIG. 13 and with repeated reference to FIG. 3A, FIG. 3B, FIG. 14A, and FIG. 14B. FIG. 14A mainly illustrates the power path of the supplying power Pg (i.e., the dashed arrows), and FIG. 14B mainly illustrates the operating method in the charging mode. The circuit structure of FIG. 14A is similar to that of FIG. 3A, differing in that FIG. 14A lacks the discharging circuit 1B, and therefore the power paths of FIG. 14A and FIG. 3A are identical. Furthermore, the operating method of FIG. 14B is identical to that of FIG. 3B and will not be further described here. Furthermore, the circuit structure, coupling relationships, and operating methods not described in FIG. 14A and FIG. 14B can be referred to in conjunction with FIG. 3A and FIG. 3B, and will not be further described here.

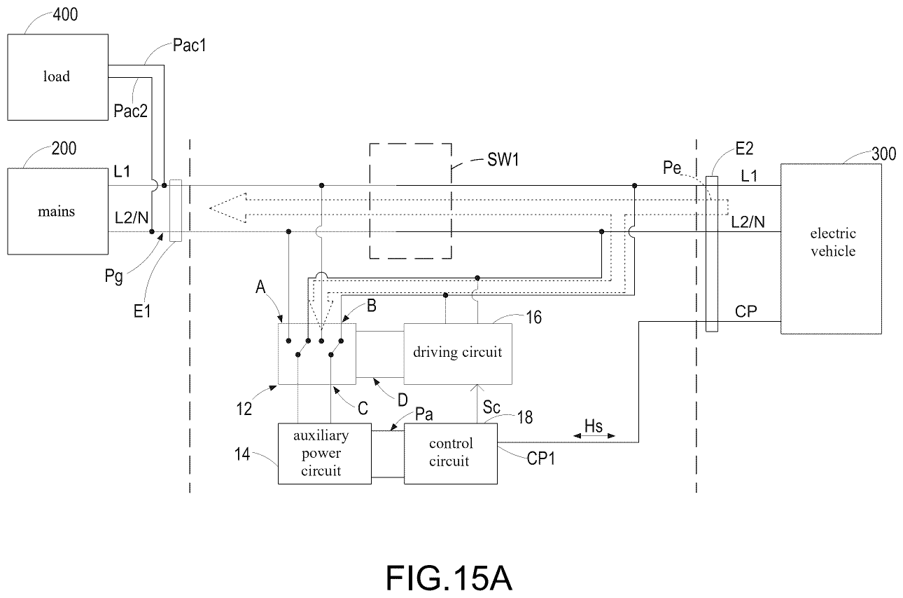

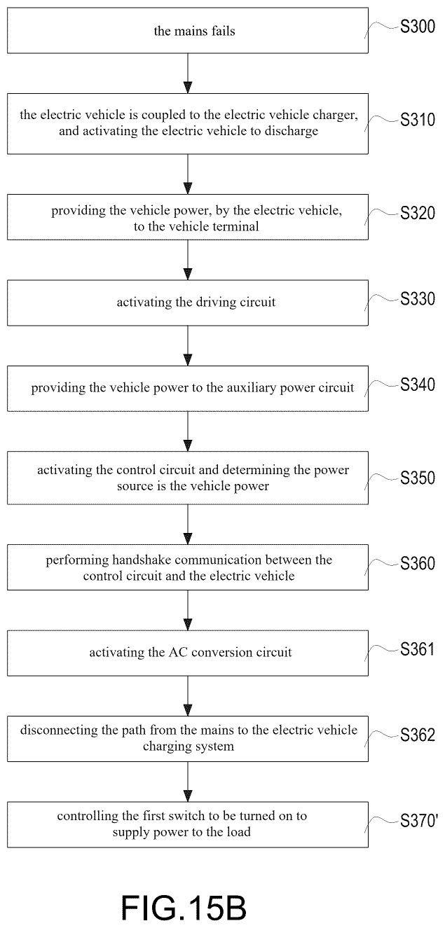

Please refer to FIG. 15A, which shows a power path diagram of the electric vehicle charger in the discharging mode according to a third embodiment of the present disclosure; please refer to FIG. 15B, which shows a flowchart of operating the electric vehicle charger in the discharging mode according to a third embodiment of the present disclosure, and also refer to FIG. 1A to FIG. 14B and with repeated reference to FIG. 4A, FIG. 4B, FIG. 15A, and FIG. 15B. FIG. 15A mainly illustrates the power path of the vehicle power Pe (i.e., dashed arrows), and FIG. 15B mainly illustrates the operating method in the discharging mode. The circuit structure of FIG. 15A is similar to that of FIG. 4A, except that FIG. 15A lacks the discharging circuit 1B, and therefore, the power path of FIG. 15A is slightly different from that of FIG. 4A. Specifically, since FIG. 15A lacks the discharging circuit 1B, when the vehicle power Pe is discharged, it is fed to the mains terminal E1 through the first switch SW1. Since the electric vehicle charger 1 in FIG. 15A transmits power through the first switch SW1 without using a converter for power conversion, the vehicle power Pe is the supplying power Pg. The supplying power Pg includes the first AC power Pac1 and the second AC power Pac2 supplied to the two live wires L1, L2. Conversely, if the electric vehicle charger 1 uses a converter for power conversion during power transmission, the vehicle power Pe is not equivalent to the supplying power Pg.

On the other hand, the operating method of FIG. 15B differs from the operating method of FIG. 4B in that FIG. 15B includes steps S361, S362, and S370′. Specifically, in step S360 of FIG. 4B, after the control circuit 18 completes the handshake communication Hs with the electric vehicle 300, the AC conversion circuit may be activated (S361). Specifically, after the control circuit 18 completes the handshake communication Hs with the electric vehicle 300, the AC conversion circuit 20 (for example, but not limited to, a split-phase conversion circuit) may be activated first to provide power conversion to balance the voltages on the two live wires L1, L2. In one embodiment, the AC conversion circuit 20 may be coupled to the electric vehicle charger 1 so that its activation and deactivation are controlled by the control circuit 18. Alternatively, the AC conversion circuit 20 may be automatically activated and deactivated through detection, or coupled to a mains manager (not shown) so that its activation and deactivation are controlled by the mains manager. Furthermore, when the AC conversion circuit 20 is activated and deactivated by the control circuit 18 and the electric vehicle charger is operating in the discharging mode (i.e., when the electric vehicle 300 provides the vehicle power Pe), the control circuit 18 activates the AC conversion circuit 20 to control the AC conversion circuit 20 to split-phase-convert the supplying power Pg into a first AC power Pac1 and a second AC power Pac2 with a specific phase difference, thereby adjusting and balancing the voltages on the two live wires L1, L2. In particular, in one embodiment, if the electric vehicle charging system 100 does not include the AC conversion circuit 20, or if the AC conversion circuit 20 is not controlled by the electric vehicle charger 1, step S361 may be omitted.

Afterward, the path between the AC power and the electric vehicle charging system is disconnected (S362). Specifically, when the control circuit 18 is enabled and the operating mode is confirmed to be the discharging mode (i.e., when the electric vehicle 300 provides the vehicle power Pe), the automatic transfer switch ATS can disconnect the path between the mains 200 and the electric vehicle charging system 100, thereby preventing the mains 200 from being fed. In one embodiment, the automatic transfer switch ATS may be coupled to the electric vehicle charger 1 so that its switching is controlled by the control circuit 18. Alternatively, the automatic transfer switch ATS can switch automatically through detection, or it can be coupled to a mains manager (not shown) so that its switching is controlled by the mains manager. In particular, in one embodiment, if the electric vehicle charging system 100 is in the vehicle-to-grid operation, step S362 may be omitted. Finally, the first switch is controlled to be turned on to supply power to the load (S370′). When the control circuit 18 completes the handshake communication Hs with the electric vehicle 300, confirms that the operating mode is discharging mode, and both the AC conversion circuit 20 and the automatic transfer switch ATS have been set, the electric vehicle 300 and the electric vehicle charger 1 are ready to complete the preparatory steps for the discharging operation. Therefore, the control circuit 18 controls the first switch SW1 to be turned on to short-circuit the path from the electric vehicle 300 to the load 400, thereby allowing the vehicle power Pe to supply power to the load 400. In particular, the circuit structure, coupling relationship, and operating method not illustrated in FIG. 15A and FIG. 15B may be referred to in conjunction with FIG. 4A and FIG. 4B and will not be further described here.

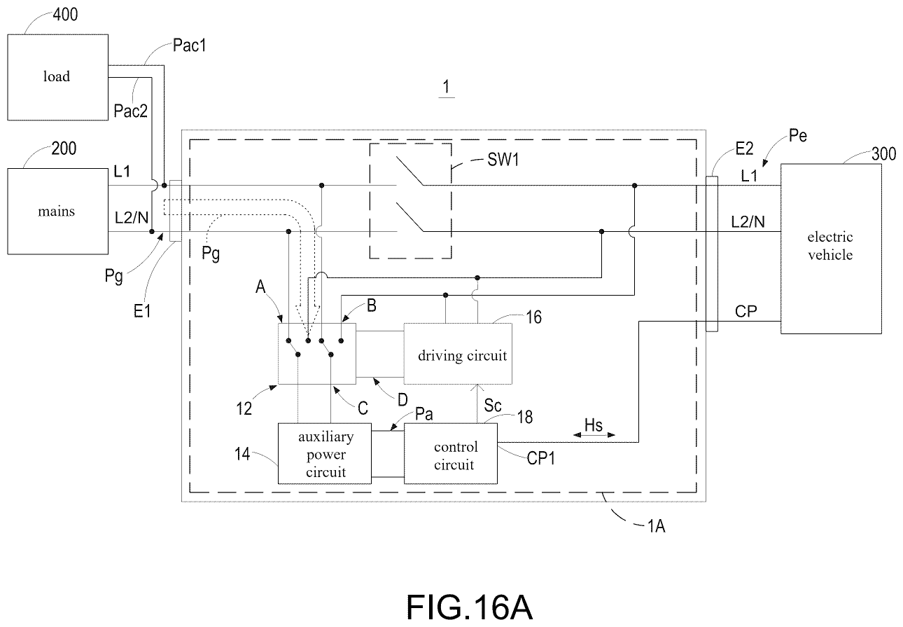

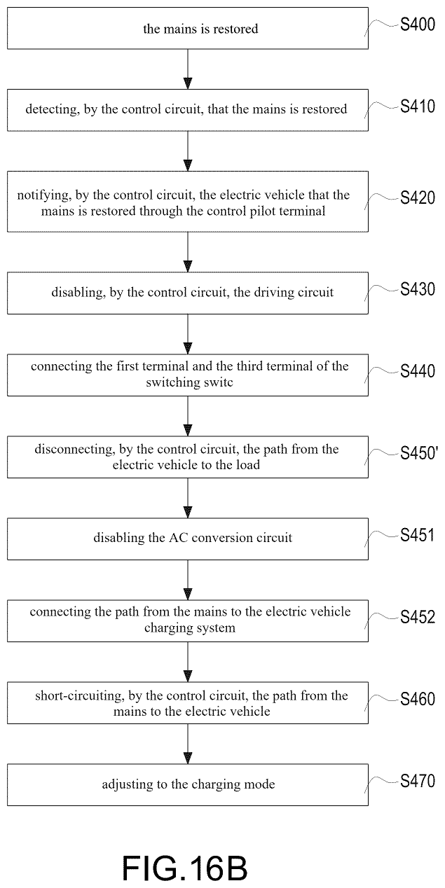

Please refer to FIG. 16A, which shows a power path diagram of the electric vehicle charger when the mains is restored according to a third embodiment of the present disclosure; please refer to FIG. 16B, which shows a flowchart of operating the electric vehicle charger when the mains is restored according to a third embodiment of the present disclosure, and also refer to FIG. 1A to FIG. 15B and with repeated reference to FIG. 6A, FIG. 6B, FIG. 16A, and FIG. 16B. FIG. 16A mainly illustrates the power path (i.e., dashed arrows) of the supplying power Pg when the mains is restored, and FIG. 16B mainly illustrates the operating method when the mains is restored. The circuit structure of FIG. 16A is similar to that of FIG. 6A, except that FIG. 16A does not include the discharging circuit 1B, and therefore, the power paths of FIG. 16A and FIG. 6A are identical.

On the other hand, the operating method of FIG. 16B differs from the operating method of FIG. 6B in that FIG. 16B includes steps S450′, S451, and S452. Specifically, in step S440 of FIG. 6B, after the first terminal A and the third terminal C of the switching switch 12 are connected, the control circuit disconnects the path from the electric vehicle to the load (S450′). That is, the control circuit 18 can disconnect the path from the electric vehicle 300 to the load 400 by controlling the first switch SW1 to be turned off. Furthermore, since the vehicle power Pe is interrupted and not supplied power to the load 400, the AC conversion circuit 20 is no longer required to adjust and balance the first AC power Pac1 and the second AC power Pac2 on the two live wires L1, L2. Therefore, the AC conversion circuit is disabled (S451) to avoid additional power consumption. Similar to FIG. 15B, the AC conversion circuit 20 can be controlled by the control circuit 18, a mains manager (not shown), or automatically activated and deactivated through detection. Furthermore, in one embodiment, when the electric vehicle charging system 100 does not include the AC conversion circuit 20, or the AC conversion circuit 20 is not controlled by the electric vehicle charger 1, step S451 may be omitted.

Afterward, the path between the mains and the electric vehicle charging system is connected (S452). Specifically, when the control circuit 18 is enabled and confirms that the mains 200 has been restored and the operating mode is to be adjusted to the charging mode (i.e., when the vehicle power Pe provided by the electric vehicle 300 is adjusted to the supplying power Pg provided by the mains 200), the automatic transfer switch ATS can switch the path between the mains 200 and the electric vehicle charging system 100 so that the mains 200 can supply power to the load 400. Similar to FIG. 15B, the automatic transfer switch ATS can be controlled by the control circuit 18 or the mains manager, or it can be automatically switched through detection. In particular, in one embodiment, if the electric vehicle charging system 100 has a vehicle-to-grid operation and the automatic transfer switch ATS has already connected the path between the mains 200 and the electric vehicle charging system 100, step S452 may be omitted. Afterward, when the electric vehicle 300 receives the power supply stop notification from the control circuit 18, it stops supplying the vehicle power Pe. After the control circuit 18 confirms that the electric vehicle 300 has stopped supplying the vehicle power Pe, the process proceeds to step S460 in FIG. 16B. In particular, the circuit structure, coupling relationships, and operating methods not described in FIG. 16A and FIG. 16B may also refer to FIG. 6A and FIG. 6B, and will not be further described here.

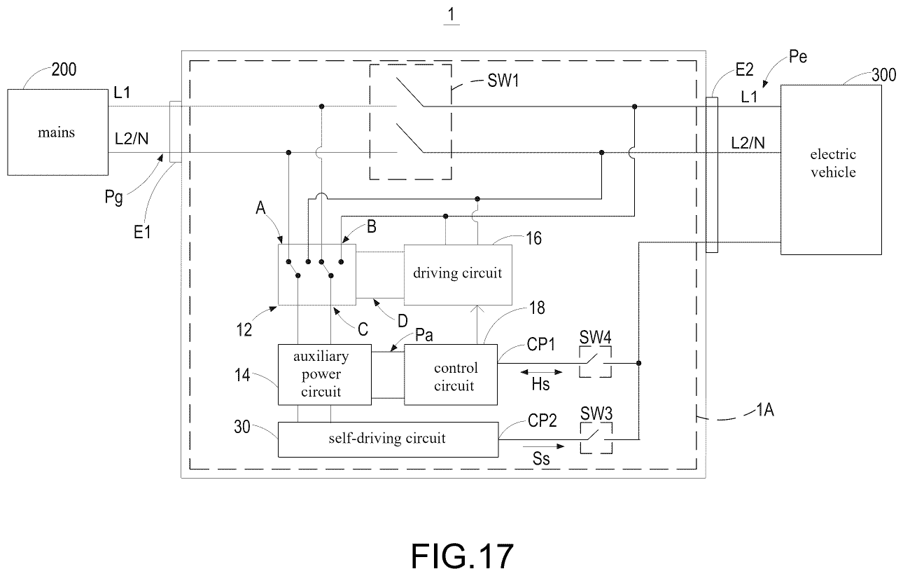

Please refer to FIG. 17, which shows a block circuit diagram of the electric vehicle charger according to a fourth embodiment of the present disclosure, and also refer to FIG. 1A to FIG. 16B and with repeated reference to FIG. 1B, FIG. 8A, and FIG. 17. The difference between FIG. 17 and FIG. 8A is that FIG. 17 does not include the discharging circuit 1B, and therefore the circuit structure of FIG. 17 does not include the second switch SW2 and the AC conversion circuit 20. Furthermore, the operating method of the electric vehicle charger 1 in FIG. 17 is the same as that shown in FIG. 8B and will not be further described here. Therefore, when the control circuit 18 is enabled (i.e., in normal operation), the control circuit 18 can control the first switch SW1, the switching switch 12, the auxiliary power circuit 14, and the driving circuit 16 to control the electric vehicle charger 1 to provide the supplying power Pg to charge the electric vehicle 300 or to provide the vehicle power Pe to discharge the load 400. In particular, in one embodiment, the circuit structure, coupling relationship, and operating method not described in FIG. 17 may also refer to FIG. 8A and FIG. 8B, and will not be further described here.

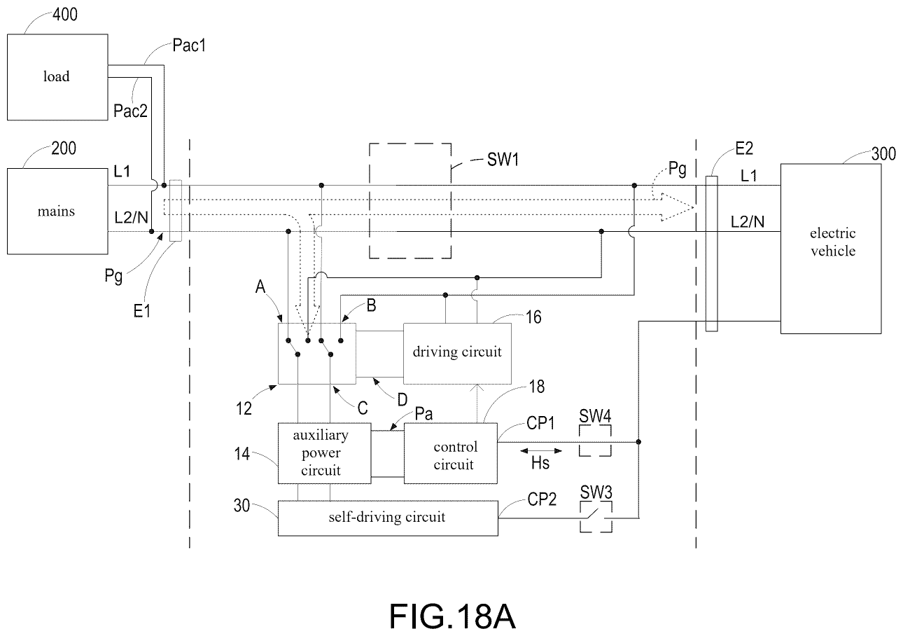

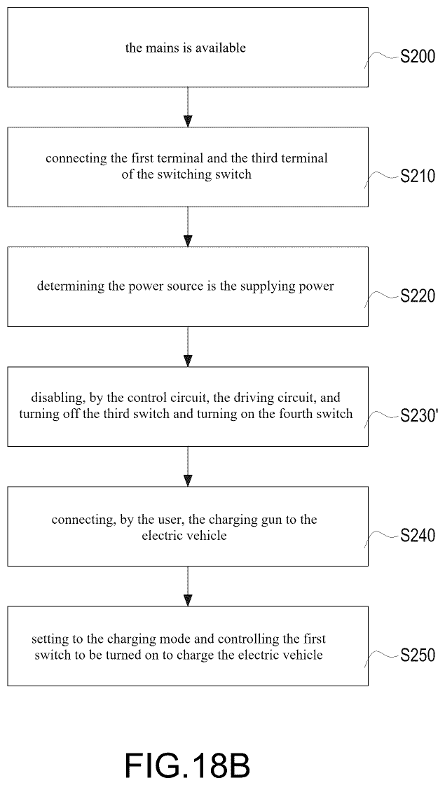

Please refer to FIG. 18A, which shows a power path diagram of the electric vehicle charger in the charging mode according to a fourth embodiment of the present disclosure; please refer to FIG. 18B, which shows a flowchart of operating the electric vehicle charger in the charging mode according to a fourth embodiment of the present disclosure, and also refer to FIG. 1A to FIG. 17 and with repeated reference to FIG. 9A, FIG. 9B, FIG. 14A, FIG. 14B, FIG. 18A, and FIG. 18B. FIG. 18A mainly illustrates the power path of the supplying power Pg (i.e., dashed arrows), and FIG. 18B mainly illustrates the operating method in the charging mode. The circuit structure of FIG. 18A is similar to that of FIG. 9A, differing in that FIG. 18A lacks the discharging circuit 1B, and therefore, the power paths of FIG. 18A and FIG. 9A are identical. Furthermore, the operating method of FIG. 18B is identical to that of FIG. 9B and will not be further described here. Furthermore, the circuit structure, coupling relationships, and operating methods not described in FIG. 18A and FIG. 18B may be referred to in conjunction with FIG. 9A and FIG. 9B, and will not be further described here.

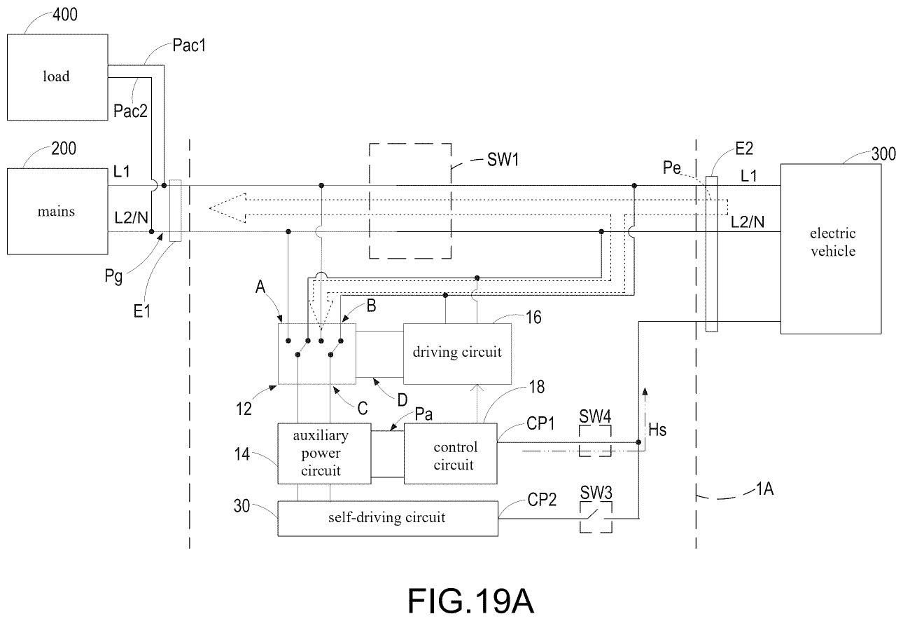

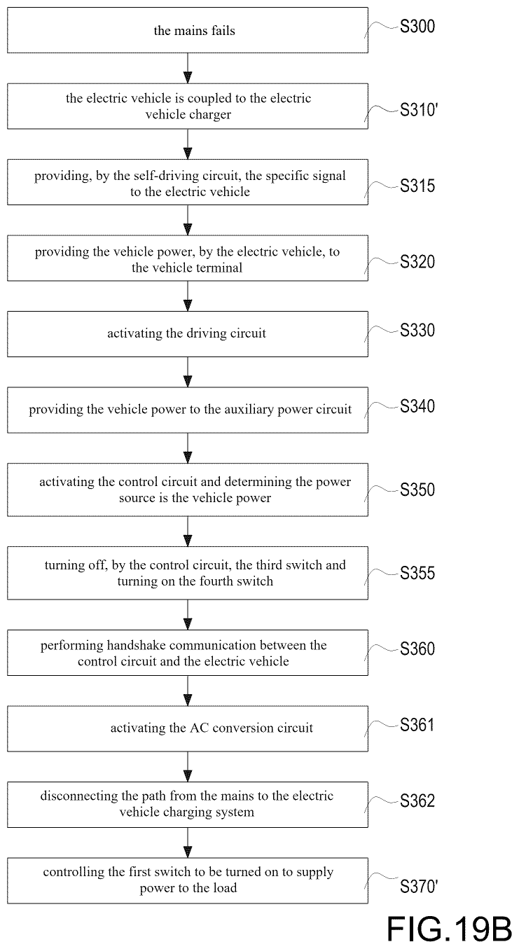

Please refer to FIG. 19A, which shows a power path diagram of the electric vehicle charger in the discharging mode according to a fourth embodiment of the present disclosure; please refer to FIG. 19B, which shows a flowchart of operating the electric vehicle charger in the discharging mode according to a fourth embodiment of the present disclosure, and also refer to FIG. 1A to FIG. 18B and with repeated reference to FIG. 10A to FIG. 11B, FIG. 15A, FIG. 15B, FIG. 19A, and FIG. 19B. FIG. 19A mainly illustrates the power flow of the vehicle power Pe (i.e., the dashed arrows), and FIG. 19B mainly illustrates the operating method in the discharging mode. The circuit structure of FIG. 19A is similar to that of FIG. 10A, except that FIG. 19A lacks the discharging circuit 1B, and therefore, the power flow of FIG. 19A is slightly different from that of FIG. 10A. The differences between the two components can be referred to in conjunction with FIG. 15A and its related description, and will not be further described here. On the other hand, the operating method shown in FIG. 19B differs from the operating methods shown in FIG. 10C and FIG. 11B in that FIG. 19B includes steps S361, S362, and S370′. In particular, steps S361, S362, and S370′ may also refer to FIG. 15B and its related description, and will not be further described here.

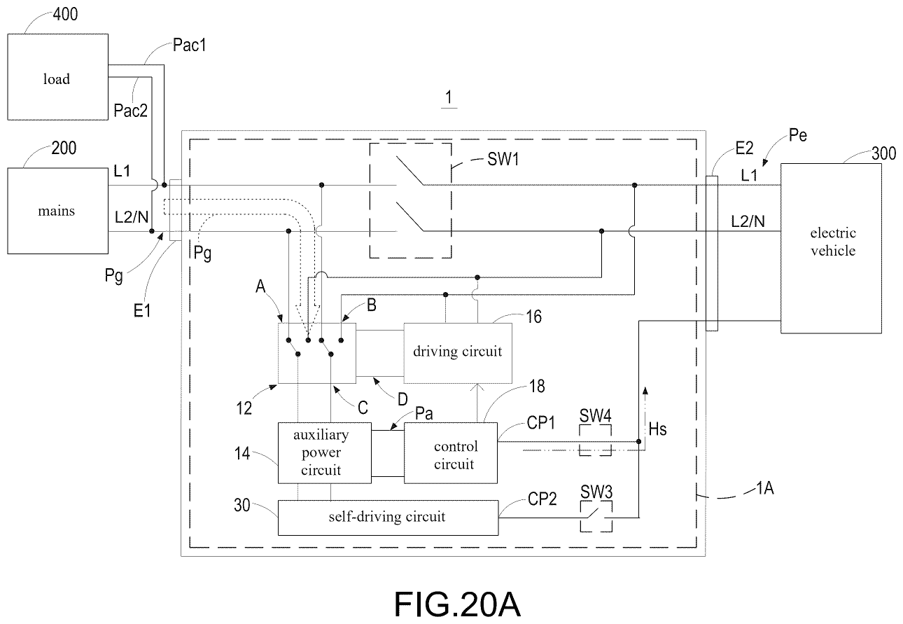

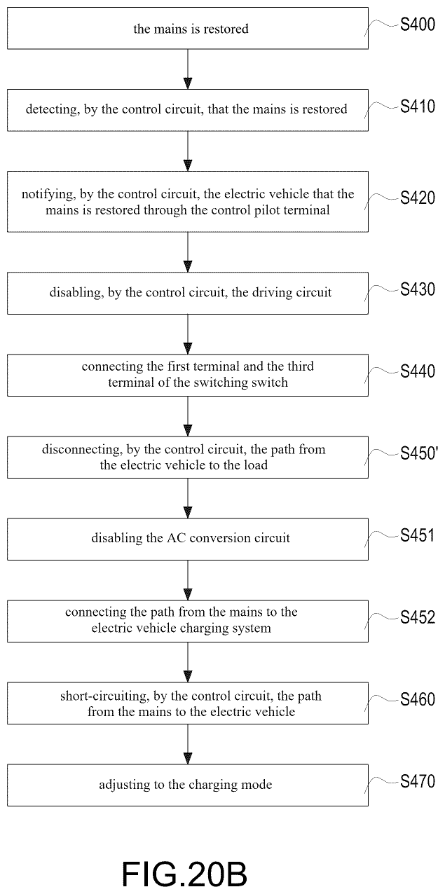

Please refer to FIG. 20A, which shows a power path diagram of the electric vehicle charger when the mains is restored according to a fourth embodiment of the present disclosure; please refer to FIG. 20B, which shows a flowchart of operating the electric vehicle charger when the mains is restored according to a fourth embodiment of the present disclosure, and also refer to FIG. 1A to FIG. 19B and with repeated reference to FIG. 12A and FIG. 12B, FIG. 16A, FIG. 16B, FIG. 20A, and FIG. 20B. FIG. 20A mainly illustrates the power path (i.e., dashed arrows) of the supplying power Pg when the mains is restored, and FIG. 20B mainly illustrates the operating method when the mains is restored. The circuit structure of FIG. 20A is similar to that of FIG. 12A, except that FIG. 20A lacks the discharging circuit 1B, and therefore the power path of FIG. 20A is slightly different from that of FIG. 12A. The differences between the two components can be referred to in conjunction with FIG. 16A and its related description, and will not be further described here. On the other hand, the operating method of FIG. 20B differs from the operating method of FIG. 12B in that FIG. 20B includes steps S450′, S451, and S452. In particular, steps S450′, S451, and S452 can be referred to in conjunction with FIG. 16B and its related description, and will not be further described here.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An electric vehicle charging system configured to couple to an electric vehicle, a mains, and a load, the electric vehicle charging system comprising:
an electric vehicle charger coupled to the electric vehicle, the mains, and the load, and the electric vehicle charger comprising:
a first switch, a first terminal of the first switch coupled to the mains through a mains terminal, and a second terminal of the first switch coupled to the electric vehicle through a vehicle terminal,
a switching switch comprising a first terminal, a second terminal, a third terminal, and a control terminal, the first terminal of the switching switch coupled between the first switch and the mains terminal, and the second terminal of the switching switch coupled between the first switch and the vehicle terminal,
an auxiliary power circuit coupled to the third terminal of the switching switch,
a driving circuit coupled to the second terminal of the switching switch and the control terminal of the switching switch, and
a control circuit coupled to the auxiliary power circuit,
wherein when the mains fails and the electric vehicle provides a vehicle power to the vehicle terminal, the driving circuit is configured to receive the vehicle power and control the second terminal and the third terminal of the switching switch to be connected through the control terminal so that the auxiliary power circuit receives the vehicle power from the third terminal, and accordingly the auxiliary power circuit is configured to convert the vehicle power into an auxiliary power to activate the control circuit.

2. The electric vehicle charging system as claimed in claim 1, wherein when the mains fails and the control circuit receives the auxiliary power, the control circuit is configured to enable driving circuit and drive the driving circuit to control the second terminal and the third terminal of the switching switch to be continuously connected so that the auxiliary power circuit is configured to continuously receive the vehicle power through a path from the second terminal to the third terminal of the switching switch.

3. The electric vehicle charging system as claimed in claim 1, wherein when the electric vehicle supplies power to the load and the mains restores, the control circuit is configured to disable the driving circuit so that the first terminal and the third terminal of the switching switch are connected, and therefore the auxiliary power circuit is configured to continuously receive a supplying power provided by the mains through a path from the first terminal to the third terminal of the switching switch and convert the supplying power into the auxiliary power.

4. The electric vehicle charging system as claimed in claim 1, wherein the driving circuit comprises:
a power supply circuit coupled to the vehicle terminal, the control circuit, and the switching switch, and configured to convert the vehicle power into a driving power,
wherein when the auxiliary power circuit supplies the auxiliary power, the control circuit is configured to disable the power supply circuit so that the power supply circuit fails to supply the driving power and the first terminal and the third terminal of the switching switch are connected; when the auxiliary power circuit does not supply the auxiliary power and the power supply circuit receives the vehicle power, the power supply circuit is enabled to provide the driving power so that the second terminal and the third terminal of the switching switch are connected according to the driving power.

5. The electric vehicle charging system as claimed in claim 1, wherein the electric vehicle charger further comprises:
a second switch, a first terminal of the second switch coupled to the second terminal of the switching switch, and a second terminal of the second switch coupled to the load through a load terminal, and
an AC conversion circuit coupled to the second switch and the vehicle terminal, and configured to split-phase-convert the vehicle power into a first AC power and a second AC power having a specific phase difference and provide the first AC power and the second AC power to the load terminal through the second switch,
wherein when the control circuit sets an operating mode of the electric vehicle charger to a discharging mode in which the electric vehicle discharges the load, the control circuit is configured to control the first switch to be turned off and control the second switch to be turned on so that the electric vehicle supplies power to the load through the second switch, and
wherein when the control circuit sets the operating mode of the electric vehicle charger to a charging mode in which the mains charges the electric vehicle, the control circuit is configured to control the first switch to be turned on and control the second switch to be turned off so that the mains charges the electric vehicle through the first switch.

6. The electric vehicle charging system as claimed in claim 5, further comprising:
an automatic transfer switch coupled between the load terminal, the load, and the mains,
wherein the control circuit is configured to control the automatic transfer switch to selectively switch the electric vehicle or the mains to supply power to the load.

7. The electric vehicle charging system as claimed in claim 1, wherein when the control circuit sets an operating mode of the electric vehicle charger to a discharging mode in which the electric vehicle discharges the load, the control circuit is configured to control the first switch to be turned on so that the electric vehicle supplies power to the load through the first switch, and
wherein when the control circuit sets the operating mode of the electric vehicle charger to a charging mode in which the mains charges the electric vehicle, the control circuit is configured to control the first switch to be turned on so that the mains charges the electric vehicle through the first switch.

8. The electric vehicle charging system as claimed in claim 7, further comprising:
an automatic transfer switch coupled between the mains terminal, the mains, and the load,
wherein the control circuit is configured to control the automatic transfer switch to selectively switch the electric vehicle or the mains to supply power to the load, and
an AC conversion circuit coupled between the automatic transfer switch and the load,
wherein the control circuit is configured to control the AC conversion circuit to split-phase-convert the supplying power into a first AC power and a second AC power having a specific phase difference so as to balance the supplying power.

9. The electric vehicle charging system as claimed in claim 1, further comprising:
a self-driving circuit comprising a first control pilot terminal coupled to the vehicle terminal,
wherein when the mains fails and the electric vehicle is coupled to the vehicle terminal, the self-driving circuit is configured to provide a specific signal to the electric vehicle through the first control pilot terminal so as to notify the electric vehicle to provide the vehicle power through the specific signal, and
wherein a third switch is provided between the first control pilot terminal and the vehicle terminal, and a fourth switch is provided between a second control pilot terminal of the control circuit and the vehicle terminal; when the mains fails, the third switch is turned on and the fourth switch is turned off so that when electric vehicle is coupled to the vehicle terminal, the specific signal is provided to the vehicle terminal through the third switch.

10. The electric vehicle charging system as claimed in claim 9, wherein when the control circuit is enabled, the control circuit is configured to control the third switch to be turned off and control the fourth switch to be turned on so as to communicate with the electric vehicle through a path from the second control pilot terminal to the fourth switch, or
wherein the control circuit is coupled to the self-driving circuit, and when the control circuit is enabled, the control circuit is configured to continuously control the third switch to be turned on and control the fourth switch to be turned off so as to communicate with the electric vehicle through a path from the first control pilot terminal to the third switch.

11. The electric vehicle charging system as claimed in claim 9, wherein the self-driving circuit comprises:
a power-supplying device configured to provide an energy storage power, and
a signal generation circuit coupled to the power-supplying device,
wherein when the electric vehicle is coupled to the vehicle terminal, the signal generation circuit is configured to provide the specific signal to the vehicle terminal according to the energy storage power.

12. A method for operating an electric vehicle charging system, the electric vehicle charging system comprising an electric vehicle charger coupled to an electric vehicle, a mains, and a load; the electric vehicle charger comprising a switching switch having a first terminal, a second terminal, a third terminal, an auxiliary power circuit, a driving circuit, and a control circuit, the method comprising steps of:
activating the driving circuit by receiving, by the driving circuit, a vehicle power when the mains fails and the electric vehicle provides the vehicle power to the electric vehicle charger,
controlling, by the driving circuit, the second terminal and the third terminal of the switching switch to be connected so that the auxiliary power circuit receives the vehicle power through a path from the second terminal to the third terminal, and
converting, by the auxiliary power circuit, the vehicle power into an auxiliary power to activate the control circuit.

13. The method for operating the electric vehicle charging system as claimed in claim 12, further comprising steps of:
determining, by the control circuit, whether a power source is the vehicle power when the mains fails and the control circuit is activated,
enabling, by the control circuit, the driving circuit and driving the driving circuit to control the second terminal and the third terminal of the switching switch to be continuously connected when the power source is the vehicle power, and
communicating, by the control circuit, with the electric vehicle and short-circuiting a path from the electric vehicle to the load so that the vehicle power is provided to supply power to the load.

14. The method for operating the electric vehicle charging system as claimed in claim 13, further comprising a step of:
controlling, by the control circuit, an AC conversion circuit to split-phase-convert the vehicle power into a first AC power and a second AC power having a specific phase difference and providing the first AC power and the second AC power to supply power to the load.

15. The method for operating the electric vehicle charging system as claimed in claim 13, further comprising a step of:
controlling, by the control circuit, an AC conversion circuit to split-phase-convert the supplying power provided by the mains into a first AC power and a second AC power having a specific phase difference so as to balance the supplying power.

16. The method for operating the electric vehicle charging system as claimed in claim 12, further comprising a step of:
controlling, by the control circuit, an automatic transfer switch to selectively switch the electric vehicle or the mains to supply power to the load.

17. The method for operating the electric vehicle charging system as claimed in claim 12, further comprising steps of:
connecting the first terminal and the third terminal of the switching switch when the mains is available, and providing, by the mains, a supplying power to the auxiliary power circuit through a path from the first terminal to the third terminal,
converting, by the auxiliary power circuit, the supplying power into the auxiliary power and activating the control circuit through the auxiliary power,
determining, by the control circuit, whether a power source is the supplying power,
disabling, by the control circuit, the driving circuit so that the first terminal and the third terminal of the switching switch are continuously connected when the power source is the supplying power,
performing, by the control circuit, a handshake communication with the electric vehicle and short-circuiting a path from the mains to the electric vehicle so that the supplying power charges the electric vehicle when the power source is the supplying power and the control circuit determines that the electric vehicle is coupled to the electric vehicle charger,
notifying, by the control circuit, the electric vehicle through the handshake communication to confirm whether to adjust an operating mode from a discharging mode in which the electric vehicle discharges the load to a charging mode in which the mains charges the electric vehicle when the electric vehicle supplies power to the load and the mains is restored,
disabling, by the control circuit, the driving circuit so that the first terminal and the third terminal of the switching switch are connected when the operating mode is confirmed to be adjusted to the charging mode, and
disconnecting, by the control circuit, a path from the electric vehicle to the load, and short-circuiting the path from the mains to the electric vehicle so as to adjust from supplying power to the load by the vehicle power to charging the electric vehicle by the supplying power.

18. The method for operating the electric vehicle charging system as claimed in claim 12, further comprising steps of:
providing, by a self-driving circuit, a specific signal to the electric vehicle so as to notify the electric vehicle to provide the vehicle power through the specific signal when the mains fails and the electric vehicle is coupled to the electric vehicle charger,
short-circuiting a first communication path from the self-driving circuit to the electric vehicle and disconnecting a second communication path from the control circuit to the electric vehicle so that the self-driving circuit provides the specific signal to the electric vehicle through the first communication path to notify the electric vehicle to provide the vehicle power when the mains fails and the electric vehicle is coupled to the electric vehicle charger, and
providing, by the self-driving circuit, the specific signal according to an energy storage power when the electric vehicle is coupled to the electric vehicle charger.

19. The method for operating the electric vehicle charging system as claimed in claim 18, further comprising a step of:
disconnecting the first communication path and short-circuiting the second communication path so that the control circuit performs a handshake communication with the electric vehicle through the second communication path when the control circuit is enabled.

20. The method for operating the electric vehicle charging system as claimed in claim 18, wherein the control circuit is coupled to the self-driving circuit, and the method further comprises a step of:
continuously short-circuiting the first communication path and disconnecting the second communication path so that the control circuit performs a handshake communication with the electric vehicle through the first communication path when the control circuit is enabled.
